(19) United States
(12) Patent Application Publication
(10) Pub. No.: US 2012/0213968 A1
(43) Pub. Date: Aug. 23, 2012

(54) OPTICAL LAMINATE FILM AND DISPLAY DEVICE

(76) Inventors: Hidemasa Hosoda, Minami-Ashigara-shi (JP); Tatsuya Nomura, Minami-Ashigara-shi (JP); Takashi Kobayashi, Minami-Ashigara-shi (JP)

(21) Appl. No.: 13/402,357

(22) Filed: Feb. 22, 2012

(30) Foreign Application Priority Data
Feb. 23, 2011 (JP) 2011-037568
Mar. 3, 2011 (JP) 2011-046540
Mar. 30, 2011 (JP) 2011-075923
Aug. 19, 2011 (JP) 2011-179830

(51) Int. Cl. B32B 5/16

(52) U.S. Cl. 428/143; 428/340; 428/338

(57) ABSTRACT

A stably-manufacturable optical laminate film and display device having an excellent outer appearance without rainbow-like unevenness are provided. An optical laminate film includes a support, an easily-adhesive layer provided on one surface of the support, a transparent layer provided on the other surface of the support. In the optical laminate film, the transparent layer contains at least two types of translucent particles having different volume average particle diameters, and a total sum S of the translucent particles satisfies 30 mg/m²≦S≦500 mg/m².

### BACKGROUND OF THE INVENTION

1. Field of the Invention

The present invention relates to optical laminate films and display devices and, in particular, to an optical laminate film and display device suitably used as a member of a backlight unit of a liquid-crystal display.

2. Description of the Related Art

An optical laminate film such as a prism sheet, a lens sheet, and a diffusion sheet is widely used as a member of a backlight unit of a flat panel display (such as TV or a monitor). The optical laminate film includes a support and many sheets such as a prism sheet and lens sheet refracting incident light in a predetermined direction and a diffusion sheet variously refracting incident light for diffusion. Japanese Patent Application Laid-Open No. 2009-175646 discloses an optical laminate film with an upper diffusion sheet arranged on a lens sheet.

In the recent years, for the purpose of reducing the number of components and cost, an optical laminate film without an upper diffusion sheet arranged on a prism sheet has been considered.

For example, Japanese National Publication of International Patent Application No. 2001-524225 discloses an optical laminate film including a prism layer arranged on one surface of a support and a resin layer containing particles arranged on the other surface of the support. In this gazette, by setting a haze value equal to or higher than 20% and equal to or lower than 60%, scratches, white spots, stains, and others are hidden. In Japanese Patent Application Laid-Open No. 2002-243920, by controlling a convex height by particles, scratches and luminance unevenness are resolved.

The resin layer containing particles arranged on the back surface of the prism layer may be desired to have a function of preventing the occurrence of Newton's rings with an adjacent smooth member (for example, a light-guiding plate) and preventing an adjacent member (for example, a light-guiding plate, another prism sheet, or a diffusion sheet) from being damaged. U.S. Pat. No. 6,560,023 discloses that a damage on an adjacent member is prevented by uniformly setting a half-width of a particle diameter distribution of particles equal to or smaller than 1 μm.

### SUMMARY OF THE INVENTION

Since the optical laminate film described in Japanese National Publication of International Patent Application No. 2001-524225 does not include an upper diffusion sheet, it is advantageous in the number of components and cost reduction. However, it has been found that, in a backlight unit for use in a flat panel display, if an optical laminate film where a prism sheet is present on a top layer, rainbow-colored unevenness (rainbow-like unevenness) disadvantageously appears.

This rainbow-like unevenness is different from conventionally-thought unevenness occurring due to interference by film lamination, and is caused by chromatic dispersion. Moreover, since it is difficult to obtain a prism-dedicated resin without chromatic dispersion in refractive index, rainbow-like unevenness is fundamentally problematic.

For stable production without rainbow-like unevenness, the inventors have found that the amount of addition of particles is required to be equal to or larger than 30 mg/m². However, under circumstances where the amount of addition of particles is relatively large, if only the particles with a uniform particle diameter are used as in U.S. Pat. No. 6,560,023, coagulation of particles occurs after coating and drying, and the surface of the coating becomes varied from a macroscopic viewpoint. As a result, it has been found that the outer appearance of the film disadvantageously becomes degraded.

As a result of diligent studies by the inventors, it has been found that the outer appearance is dramatically improved by adding two types of particles having different volume average particle diameters.

An object of the present invention is to provide a stably-manufacturable optical laminate film and display device having an excellent outer appearance without rainbow-like unevenness.

An optical laminate film according to an aspect of the present invention includes: a support; an easily-adhesive layer provided on one surface of the support; and a transparent layer made of translucent resin provided on another surface of the support, wherein the transparent layer contains at least two types of translucent particles having different volume average particle diameters, and a total sum S of the translucent particles satisfies 30 mg/m²≦S≦500 mg/m². Preferably, a translucent particle having a smallest volume average particle diameter and a translucent particle having a largest volume average particle diameter have a difference in volume average particle diameter equal to or larger than 1 μm. Particles each having a volume average particle diameter equal to or larger than 1 μm preferably occupy more than 10% of the total.

The inventors have found that when the total sum S of the translucent particles satisfies 30 mg/m²≦S≦500 mg/m² and the film includes at least two types of translucent particles having different volume average particle diameters, rainbow-like unevenness can be prevented, a truly excellent outer appearance can be obtained, and manufacture stability can be achieved, thereby leading to the present invention.

In the optical laminate film according to another aspect, a volume average particle diameter r of all of the translucent particles satisfies 1.0 μm≦r≦3.0 μm.

In the optical laminate film according to still another aspect, an average film thickness t of the transparent layer satisfies r/4≦t<r with respect to the volume average particle diameter r of all of the translucent particles.

In the optical laminate film according to still another aspect, a haze value is equal to or larger than 20% and equal to or smaller than 60%.

In the optical laminate film according to still another aspect, at least one of the translucent particles has a CV value equal to or lower than 30% and the CV value is defined as follows: CV value=[standard deviation of volume average particle diameter of the translucent particles]/[average particle diameter of the translucent particles].

In the optical laminate film according to still another aspect, at least one of the translucent particles has a volume average particle diameter smaller than 1

In the optical laminate film according to still another aspect, the transparent layer includes two layers of, from a side close to the support, a first transparent layer and a second transparent layer.

In the optical laminate film according to still another aspect, the second transparent layer is an inorganic layer made of a silica-based compound.

In the optical laminate film according to still another aspect, the transparent layer includes either one of metal oxide particles exhibiting conductivity by electron conduction and a π electron-conjugated conductive polymer, and the transparent layer has a surface resistance equal to or lower than 10¹²Ω/sq.

In the optical laminate film according to still another aspect, the easily-adhesive layer includes either one of metal oxide particles exhibiting conductivity by electron conduction and a π electron-conjugated conductive polymer, and the easily-adhesive layer has a surface resistance equal to or lower than 10¹²Ω/sq.

In the optical laminate film according to still another aspect, a lens layer is further provided on the easily-adhesive layer.

In the optical laminate film according to still another aspect, the transparent layer has a 10-point average roughness Rz of 0.5 μm≦Rz≦1.0 μm.

A display device according to an aspect of the present invention, includes the optical laminate film according to any one of the above-described optical laminate films mounted thereon.

According to the optical laminate film of the present invention, rainbow-like unevenness can be eliminated, an excellent outer appearance can be obtained, and the optical laminate film can be stably manufactured.

### BRIEF DESCRIPTION OF THE DRAWINGS

FIG. 1 is a sectional view of an optical laminate film according to a first embodiment;

FIG. 2 is a sectional view of an optical laminate film according to a second embodiment;

FIG. 3 is a exploded view of the structure of a display device; and

FIGS. 4A to 4C are graphs each showing a relation between a particle diameter and a volume frequency.

### DETAILED DESCRIPTION OF THE PREFERRED EMBODIMENTS

Preferred embodiments of the present invention are described below according to the attached drawings. While the present invention is described based on the preferred embodiments below, modifications can be made with various techniques without deviating from the scope of the present invention, and embodiments other than the present embodiments can also be used. Therefore, all modifications within the scope of the present invention are included in the claims.

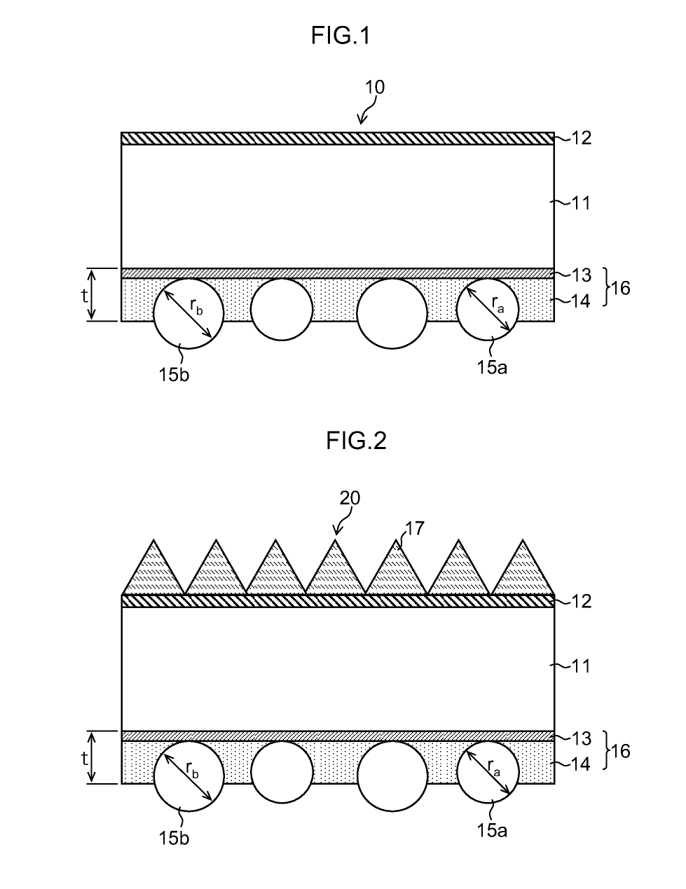

FIG. 1 is a sectional view of an optical laminate film according to a first embodiment of the present invention. The optical laminate film 10 includes a support 11, an easily-adhesive layer 12 provided on one surface of the support 11, a first transparent layer 13 provided on the other surface of the support 11, a second transparent layer 14 provided adjacently to the first transparent layer 13, and two types of translucent particles 15a and 15b having different volume average particle diameters arranged in the second transparent layer 14.

As a result of diligent studies by the inventors as to prevention of rainbow-lie unevenness and excellent coating surface, it has been found that the problems described above can be solved by including two types of translucent particles having different amounts of addition and at least different volume average particle diameters and, preferably setting a difference in volume average particle diameter between a particle having a minimum volume average particle diameter and a particle having a maximum volume average particle diameter, to be equal to or larger than 1 μm.

A total sum S of the translucent particles 15a and 15b satisfies 30 mg/m²≦S≦500 mg/m², preferably 30 mg/m²≦S≦400 mg/m², more preferably 30 mg/m²≦S≦300 mg/m², and most preferably 70 mg/m²≦S≦300 mg/m². The total sum S of the translucent particles 15a and 15b can be found by shooting the particles by an optical microscope, measuring a particle diameter of each particle and counting the number of particles within a range of a unit area (a range that can be measured without unevenness, such as 1 cm²), converting a relative density for each type of particles to weight to find a total sum, and then converting the result to weight per 1 m². Also, the particle diameter can be measured by observing the surface and the section together with SEM (scanning electron microprobe).

Regarding optical scatterability, a haze value of the optical laminate film 10 measured by a haze meter (NDH-2000, Nippon Denshoku Industries Co., Ltd.) by complying with JIS-K-7105 (JIS: Japanese Industrial Standards) is preferably within a range equal to or larger than 20% and equal to or smaller than 60%. The reason for this is as follows. When the haze value is smaller than 20%, it is difficult to mitigate rainbow-like unevenness. On the other hand, when the haze value exceeds 60%, the possibility of decreasing the luminance after the film is assembled with a backlight is increased.

Also, a transparent layer 16 preferably has a 10-point average roughness Rz of 0.5 μm≦Rz≦1.0.

When Rz is smaller than 0.5 μm, it is difficult to mitigate rainbow-like unevenness while front luminance is kept. When Rz is larger than 1.0 μm, retainability of particles may be degraded.

The easily-adhesive layer 12 is provided on one surface of the support in order to improve bondability of the support 11 with respect to an optical functional layer and increase adhesiveness with the optical functional layer.

While the transparent layer 16 arranged on the other surface of the support 11 has a two-layer structure including the first transparent layer 13 and the second transparent layer 14, in the first embodiment, the transparent layer 16 may have a one-layer structure.

While the first transparent layer 13 serves as an easily-adhesive layer between the second transparent layer 14 and the support 11 in the first embodiment. The second transparent layer 14 functions as a retaining layer retaining the translucent particles 15a and 15b. With the transparent layer 16 being configured of two layers, retainability of particles and bondability with the support 11 required for the transparent layer 16 can both be achieved.

FIG. 2 is a sectional view of an optical laminate film according to a second embodiment. An optical laminate film 20 includes a support 11, an easily-adhesive layer 12 provided on one surface of the support 11, a prism layer 17 provided as a lens layer on the easily-adhesive layer 12, a first transparent layer 13 provided on the other surface of the support 11, a second transparent layer 14 provided adjacently to the first transparent layer 13, and two types of translucent particles 15a and 15b having different volume average particle diameters arranged in the second transparent layer 14.

The optical laminate film 20 is provided with a prism layer 17 as a lens layer on the easily-adhesive layer 12 of the optical laminate film 10 of the first embodiment.

The prism layer 17 refracts incident light for gathering or diffusion. The prism layer 17 of FIG. 2 has a form in which a plurality of prisms each having a triangular section are arranged with predetermined pitches. When light enters from a transparent layer 16 side, the optical laminate film 20 having the above-structured prism layer 17 refract the incident light beam by the prisms toward a predetermined direction. As a result, light is emitted with a light distribution with a peak in the predetermined direction. For example, when the incident light beam is refracted toward a direction perpendicular to a surface of the prism (normal line direction), the light distribution has a large peak in the normal line direction. When the optical laminate film 20 is used for a backlight unit of a liquid-crystal display, front luminance of the liquid-crystal display can be improved.

However, when the transparent layer 16 containing the translucent particles 15a and 15b is not arranged on the prism layer 17, if the prism layer 17 is arranged on a backlight and the backlight is lit up and viewed from a diagonal direction, rainbow-like unevenness disadvantageously appears, that is, a portion supposed to be viewed as white is viewed as being color-shifted from white.

In the second embodiment, the prism layer 17 has a shape in which a plurality of prisms each having a triangular section are arranged with predetermined pitches. However, this is not meant to be restrictive. For example, the prism apical angle may be curved, or the prism itself may not be linear but have some undulation.

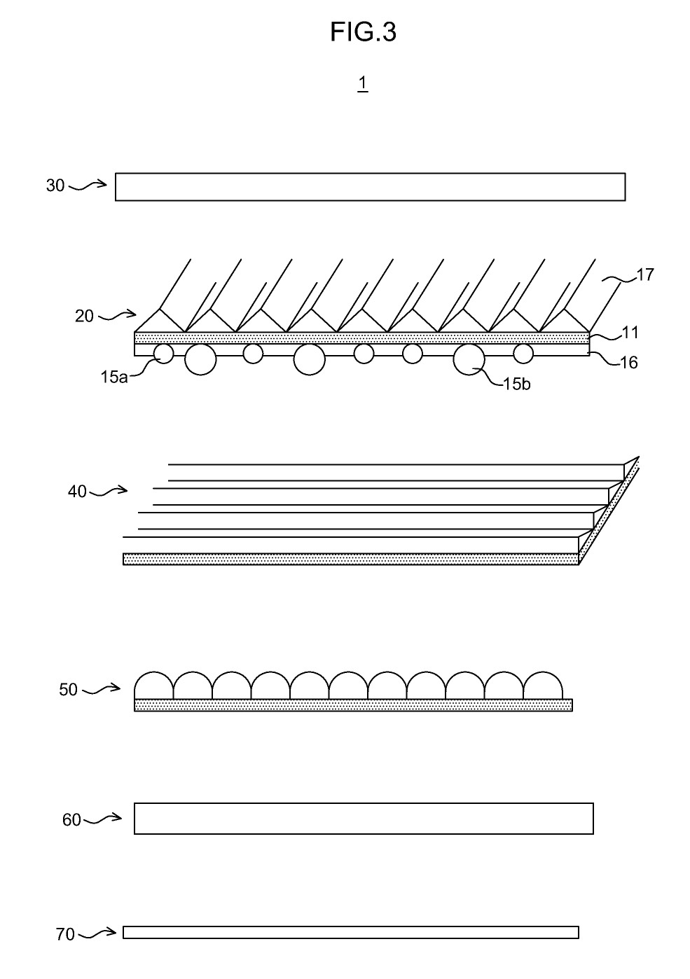

FIG. 3 is a schematic diagram showing the structure of an example of a display device using the optical laminate film 20 according to the second embodiment, and this is not particularly meant to be restrictive.

A display device 1 includes the optical laminate film 20, a liquid-crystal panel unit 30 arranged on the prism layer 17 side of the optical laminate film 20, a prism sheet 40 arranged on a transparent layer 16 side of the optical laminate film 20, a microlens sheet 50 arranged on a side of the prism sheet 40 opposite to the optical laminate film 20 side, a light-guiding plate 60 arranged on a side of the microlens sheet 50 opposite to a prism sheet 40 side, and a reflective sheet 70 arranged on a side of the light-guiding plate 60 opposite to a microlens sheet 50. Also, the device is used with lamp light incident from a side surface of the light-guiding plate 60. The display device 1 does not have a diffusion sheet between the liquid-crystal panel unit 30 and the optical laminate film 20.

The liquid-crystal panel unit 30 has a form with both surfaces of a liquid panel interposed between two optical polarizing plates. In the display device 1, a diffusion sheet can be used in place of the microlens sheet 50. Also, a direct backlight can be used in place of the light-guiding plate 60.

Various combinations of the prism sheet 40, the microlens sheet 50, the light-guiding plate 60, and the reflective sheet 70 arranged on the transparent layer 16 side of the optical laminate film 20 can be thought according to the specifications desired for the display device 1.

Next, materials and others for use in the optical laminate film of the present embodiment are described.

[Support]

The support 11 is made by forming a high polymer compound in a film shape by using a melting film-forming method or a solution film-forming method. The high polymer compound for use in the support 11 is transparent.

Preferable examples of the support 11 include polyethylene terephthalate (PET), polyethylene naphthalate (PEN), polybutylene terephthalate (PBT), polybutylene naphthalate (PBN), polyallylates, polyethersulphone, polycarbonate, polyetherketone, polysulphone, polyphenylenesulfide, polyester-based liquid-crystal polymer, triacetylcellulose, cellulose derivatives, polypropylene, polyamides, polyimide, and polycycloolefins.

Among these, PET, PEN, triacetylcellulose, and cellulose derivatives are more preferable, and PET and PEN are particularly preferable.

As the support 11, in view of a modulus of elasticity and transparency, it is preferable to use a so-called biaxial-orientation high polymer film which is obtained by stretching the high polymer compound described above formed into a long film shape, in two directions of a longitudinal direction and a width direction orthogonal to each other.

Also, at least one of the one and the other surfaces of the support 11 may be subjected to a corona discharge process. With a corona discharge process, one or both of the one and the other surfaces are subjected to hydrophilization, and wettability of various water-based coating fluids can be improved. Furthermore, a functional group such as a carboxyl group or a hydroxyl group can be introduced. With this, adhesiveness between the one surface of the support 11 and the other surface of the easily-adhesive layer 12 or between the other surface of the support 11 and the transparent layer 16 can be more increased.

The support 11 has a thickness of 100 μm to 350 μm. Within this range, an optical laminate film having an optimum thickness can be obtained as a backlight unit component.

The support 11 preferably has a refractive index of 1.40 to 1.80, although the value varies depending on the material for use. Within this range, an optical laminate film having an optimal thickness as a backlight unit component.

[Transparent Layer]

The transparent layer 16 is arranged on a side opposite to the side where the easily-adhesive layer 12 of the support 11 is provided. The transparent layer 16 may include one layer, but is preferably configured of two layers, the first transparent layer 13 and the second transparent layer 14.

In a relation with a volume average particle diameter r of all of the translucent particles 15a and 15b, the transparent layer 16 preferably has an average film thickness t satisfying r/4≦t<r, more preferably r/3≦t<r, and further preferably r/2≦t<r. If the average thickness t is smaller than r/4, bondability for retaining the translucent particles 15a and 15b may be insufficient. Also, if the average thickness t is larger than r, it is disadvantageously difficult to mitigate rainbow-like unevenness and achieve front luminance both.

In the present embodiment, with coating of a low-viscosity fluid by a wire bar, it is possible to perform precise coating achieving the film thickness described above even with small-sized particles.

(First Transparent Layer)

The first transparent layer 13 is normally formed by applying a coating fluid made of a binder, a curing agent, and a surface active agent onto the other surface of the support 11. As the material for use as the first transparent layer 13, a suitable material is preferably selected for the purpose of fixing the translucent particles 15a and 15b onto the support 11. Also, no curing agent may be used, and the binder itself may have self-crosslinking properties.

The binder used for the first transparent layer 13 is not particularly restrictive. However, in view of adhesiveness to the support 11, at least one of polyester, polyurethane, acrylic resin, and styrene-butadiene copolymer is preferable. Also, a water-soluble or water-dispersive binder is particularly preferable in view of less load on the environment.

The first transparent layer 13 may include metal oxide particles exhibiting conductivity by electron conduction. As the metal oxide particles, general metal oxides can be used, and examples include ZnO, TiO₂, SnO₂, Al₂O₃, In₂O₃, MgO, BaO, MoO₃, and composite oxides thereof, and these metal oxides may contain a small amount of any different element. Among these metal oxides, SnO₂, ZnO, TiO₂, and In₂O₃ are preferable, and SnO₂ is particularly preferable. In place of the metal oxide particles exhibiting conductivity by electron conduction, a π electron-conjugated conductive polymer may be contained, such as a polythiophene-based polymer.

By adding metal oxide particles exhibiting conductivity by electron conduction or a π electron-conjugated conductive polymer to the first transparent layer 13, the surface resistance of the first transparent layer 13 is adjusted to be equal to or lower than 10¹²Ω/sq (Ω per square). With this, sufficient antistatic prevention can be achieved, thereby preventing absorption of dust and dirt onto the optical laminate films 10 and 20.

Fine particles made of metal oxide may be contained in the first transparent layer 13 in order to adjust the refractive index of the first transparent layer 13. As the metal oxide, metal oxide with a high refractive index is preferable, such as tin oxide, zirconium oxide, zinc oxide, titanium oxide, cerium oxide, or niobium oxide because metal oxide with a high refractive index can change the refractive index even with a small amount. The particle diameter of the fine particles made of metal oxide is preferably in a range of 1 nm to 50 nm, and particularly preferably in a range of 2 nm to 40 nm. Although the amount of the fine particles of metal oxide can be determined according to a target refractive index, the fine particles are preferably contained in the first transparent layer 13 so that the mass of the fine particles is in a range of 10 to 90 when the total mass of the translucent resin is assumed to be 100, and particularly preferably in a range of 30 to 80. The first transparent layer 13 preferably has a refractive index in a range of 1.4 to 1.8.

The first transparent layer 13 preferably has a thickness of 0.05 μm to 0.3 μm. If the thickness exceeds 0.3 μm, interference unevenness due to a subtle change of the film thickness of the second transparent layer 14 may occur. If the thickness is below 0.05 μm, it is difficult to exhibit easy adhesiveness. Also, the first transparent layer 13 may partially retain the translucent particles 15a and 15b.

[Second Transparent Layer]

The second transparent layer 14 is provided so as to be in contact with the first transparent layer 13. The second transparent layer 14 is preferably a hard coat layer having high hardness and anti-damage properties. With this, the optical laminate films 10 and 20 can be prevented from being damaged.

The second transparent layer 14 retains two types of the translucent particles 15a and 15b having different volume average particle diameters (rₐ, r_{b}). A difference (r_{b}−rₐ) between two volume average particle diameters preferably exceeds 1 μm. With the difference in volume average particle diameter exceeding 1 μm, coagulation after coating of particles is suppressed, the surface becomes in good condition, and mass productivity can be achieved. Also, by using particles having different refractive indexes, scatterability can also be adjusted. Note that when the optical laminate film contain three or more types of translucent particles having different volume average particle diameters, a difference in volume average particle diameter between any two types of particles preferably exceeds 1 μm.

The second transparent layer 14 retains translucent particles 15a and 15b. The second transparent layer 14 preferably has a thickness of 0.4 μm to 3.0 μm. The thickness of the second transparent layer 14 is determined in consideration of the volume average particle diameter r of the entire translucent particles 15a and 15b.

At least one of the translucent particles preferable has a volume average particle diameter equal to or smaller than 1 μm. With the particle equal to or smaller than 1 μm being added, the sheet is further improved, and particle sedimentation in the coating fluid is suppressed to improve production stability.

A CV value (CV: coefficient of variation) of each translucent particle is preferably equal to or lower than 30%, more preferably equal to or lower than 20%, and further preferably equal to or lower than 15%. With a small CV value of each particle, monodispersibility of each particle is increased, thereby improving control over optical performance and particle missing or particle falling.

The CV value of each particle is defined as follows.

CV value (%) of each translucent particle=[standard deviation of volume average particle diameter of each particle]/[average particle diameter of each particle]

The thickness of the second transparent layer 14 can be controlled by adjusting the amount of coating of the coating fluid for the second transparent layer.

When a foreign substance is attached onto the surfaces of the optical laminate films 10 and 20, the foreign substance interferes with transmission of UV (ultra violet) light as radiation light at the time of curing for forming the prism layer 17. With the interference with transmission of UV light, the prism layer 17 is not partially cured to cause a defect. In this case, yields of the optical laminate films 10 and 20 is decreased. Moreover, the time required for curing in order to obtain a uniform prism layer 17 of the optical laminate film 20 is increased. Thus, the surface resistivity of the second transparent layer 14 at 25° C. with 40% RH (RH: Relative Humidity) is preferably equal to or larger than 10⁸Ω/sq and equal to or smaller than 10¹²Ω/sq. With this, the antistatic preventive function is provided to the optical laminate films 10 and 20.

As a method of forming the second transparent layer 14 with the above-described surface resistivity in order to provide an antistatic function to the optical laminate films 10 and 20, an ionic antistatic agent, such as cation, anion, or betaine, is preferably added to the coating fluid for the second transparent layer. Among these, a betaine-based compound having a imidazolinium skeleton, such as 2-alkyl-N-carboxyethyl-N-hydroxyethyl imidazolinium betaine, is preferable. In place of or in addition to an ionic antistatic agent, fine particles made of metal oxide, such as conductive tin oxide, indium oxide, zinc oxide, titanium oxide, magnesium oxide, or antimony oxide, may be used.

Note that the haze value can be adjusted to 20% to 60% by adjusting the total sum S of the translucent particles 15a and 15b in the second transparent layer 14.

The coating fluid for the second transparent layer for forming the second transparent layer 14, a photo-curable resin containing a photopolymerization initiator may be used, but a thermosetting coating fluid without requiring a photopolymerization initiator is preferable. That is, the second transparent layer 14 is formed by applying a thermosetting coating fluid and curing this coating fluid for the second transparent layer by heating.

As a photo-curable resin, a translucent polymer having a saturated hydrocarbon chain, or a polyether chain as a main chain is used. Also, a main binder polymer after curing preferably has a crosslink structure. As a binder polymer having a saturated hydrocarbon chain as a main chain after curing, a polymer obtained from an ethyleny unsaturated monomer selected from a first group of compounds described below. As a polymer having a polyether chain as a main chain, a polymer obtained by ring-opening an epoxy-based monomer selected from a second group of compounds described below. Furthermore, a polymer of a mixture of these monomers can be thought. As a binder polymer of the compounds in the first group having a saturated hydrocarbon chain as a main chain and having a crosslink structure, a (co)polymer of a monomer having two or more ethyleny unsaturated groups is preferable. To increase the refractive index of the obtained polymer, an aromatic ring or at least one type selected from a halogen atom other than fluorine, a sulfur atom, a phosphorus atom, and a nitrogen atom is preferably contained in the structure of the monomer. Also, examples of a monomer having two or more ethyleny unsaturated groups for use in the resin layer include ester from polyalcohol and (metha)acrylic acid {for example, ethyleneglycoldi(metha)acrylate, 1,4-cyclohexanediacrylate, pentaerythritoltetra(metha)acrylate, pentaerythritoltri(metha)acrylate, trimethylolpropanetri(metha)acylate, trimethylolethanetri(metha)acrylate, dipentaerythritoltetra(metha)acrylate, dipentaerythritolpenta(metha)acrylate, dipentaerythritolhexa(metha)acrylate, pentaerythritolhexa(metha)acrylate, 1,2,3-cyclohexanetetramethacrylate, polyurethanepolyacrylate, and polyesterpolyacrylate}, vinylbenzene and its derivatives (for example, 1,4-divinylbenzene, 4-divinylbenzoicacid-2-acryloylethylester, and 1,4-divinylcyclohexanone), vinylsulfone (for example, divynylsulfone), (metha)acrylamide (for example, methylenebisacrylamide) and others.

As a material to be cured by heat, general thermosetting resin can be used, such as a urethane resin, epoxy resin, phenol resin, melamine resin, urea resin, amino resin, or silicone-based material. In particular, since a silicone resin having a three-dimensionally-crosslinked siloxane bond has a high crosslink density, a high-hardness film can be formed.

Among these, as a material for use as the second transparent layer 14, a water-soluble or water-dispersive material is preferably used, and the use of a water-based coating fluid for the second transparent layer made of any of these materials is particularly preferable in view of reducing environmental contamination due to VOC (volatile organic compounds).

A suitably-usable coating fluid for the second transparent layer forming the second transparent layer 14 is a so-called silica-based compound, containing an aqueous solution of silanol yielded by hydrolyzing tetraalkoxysilane and an organosilicon compound represented by General Formula (1) below in an acidic aqueous solution, a water-soluble curing agent for dehydration and condensation of the silanol, and colloidal silica in which colloid particles dispersed in water have an average particle diameter equal to or larger than 3 nm and equal to or smaller than 50 nm.

R¹Si(OR²)₃ (1)

(Here, R¹ is an organic group with a carbon number equal to or larger than 1 and equal to or smaller than 15 without containing an amino base, and R² is a methyl or ethyl group)

<Organosilicon Compound of General Formula (1)>

As a preferable compound of the organosilicon compound in General Formula (1) as a first component of the coating fluid for the second transparent layer, the following can be used: vinyltrimethoxysilane, 3-methacryloxypropyltrimethoxysilane, 3-acryloxypropyltrimethoxysilane, 3-chloropropyltrimethoxysilane, 3-ureidepropyltrimethoxysilane, propyltrimethoxysilane, phenyltrimethoxysilane, 3-glycidexypropyltriethoxysilane, 2-(3,4-epoxycyclohexyl)ethyltriethoxysilane, vinyltriethoxysilane, 3-methacryloxypropyltriethoxysilane, 3-acryloxypropyltriethoxysilane, 3-chloropropyltriethoxysilane, 3-ureidepropyltriethoxysilane, propyltriethoxysilane, phenyltriethoxysilane, 3-glycidexypropylmethyldimethoxysilane, 2-(3,4-epoxycyclohexyl)ethylmethyldimethoxysilane, vinylmethyldimethoxysilane, 3-methacryloxypropylmethyldimethoxysilane, 3-acryloxypropylmethyldimethoxysilane, chloropropylmethyldimethoxysilane, propylmethyldimethoxysilane, phenylmethyldimethoxysilane, 3-glycidexypropylmethyldiethoxysilane, 2-(3,4-epoxycyclohexyl)ethylmethyldiethoxysilane, vinylmethyldiethoxysilane, 3-methacryloxypropylmethyldiethoxysilane, 3-acryloxypropylmethyldiethoxysilane, chloropropylmethyldiethoxysilane, propylmethyldiethoxysilane, phenylmethyldiethoxysilane, 3-trimethoxysilylpropyl-2-[2-(methoxyethoxy)ethoxy]ethylurethane, 3-triethoxysilylpropyl-2-[2-(methoxyethoxy)ethoxy]ethylurethane, 3-trimethoxysilylpropyl-2-[2-(methoxypropoxy)propoxy]propylurethane, and 3-triethoxysilylpropyl-2-[2-(methoxypropoxy)propoxy]propylurethane.

Among these, trialkoxysilane with n=0 is more preferable, such as 3-glycidexypropyltrimethoxysilane, 3-chloropropyltrimethoxysilane, 2-(3,4-epoxycyclohexyl)ethyltrimethoxysilane, 3-ureidepropyltriethoxysilane, 3-triethoxysilylpropyl-2-[2-(methoxyethoxy)ethoxy]ethylurethane, and 3-trimethoxysilylpropyl-2-[2-(methoxypropoxy)propoxy]propylurethane.

The organosilicon compound represented by General Formula (1) does not contain an amino group as a functional group. That is, this organosilicon compound has an organic group R¹ without an amino group. If R¹ has an amino group, when it is mixed with tetraalkoxysilane for hydrolyzation, dehydration and condensation are promoted between silanols, thereby causing the coating fluid for the second transparent layer unstable. R¹ can be an organic group having a molecular chain length with a carbon number equal to or larger than 1 and equal to or smaller than 15. However, in order to obtain the second transparent layer 14 with brittleness being more mitigated and to further improve adhesiveness between the second transparent layer 14 and the first transparent layer 13, the range of the carbon number is more preferably equal to or larger than 3 and equal to or smaller than 15 and, further preferably equal to or larger than 5 and equal to or smaller than 13. Note that with the carbon number being set equal to or smaller than 15, flexibility of the second transparent layer 14 is not so large and a sufficient hardness can be achieved, compared with the case in which the carbon number is set equal to or smaller than 16.

Then, the organic group indicated by R¹ preferably has a heteroatom, such as oxygen, nitrogen, or sulfur. With the organic group having a heteroatom, adhesiveness with the first transparent layer 13 can be further improved. In particular, an epoxy group, an amid group, an urethane group, an urea group, an ester group, a hydroxy group, or carboxyl group is preferably present in the organic group R¹. Among these, an organosilicon compound containing an epoxy group is particularly preferable because it has an effect of increasing stability of silanol in acid water.

<Tetraalkoxysilane>

By using tetraalkoxysilane as the coating fluid for the second transparent layer, the crosslink density by dehydration and condensation of silanol yielded by hydrolyzation of tetraalkoxysilane and an organosilicon compound in General Formula (1) is increased. With this, a layer harder than ever can be formed.

Tetraalkoxysilane is not particularly restrictive, but is preferably the one having a carbon number of 1 to 4, and tetramemethoxysilane and tetraethoxysilane are particularly preferable. With the carbon number being equal to or lower than 4, compared with the case in which the carbon number is equal to or higher than 5, the hydrolysis speed of tetraalkoxysilane when mixed with acid water is not too slow, and the time required for dissolution to a uniform aqueous solution becomes shorter.

When it is assumed in the general formula that the mass of the organosilicon is X1 and the mass of tetraalkoxysilane is X2, tetraalkoxysilane preferably has a mass ratio, which is found with {X2/(X1+X2)}×100, in a range equal to or larger than 20% and equal to or smaller than 95% and, more preferably, in a range equal to or larger than 30% and equal to or smaller than 90%. With the mass ratio being set in this range, crosslink density can be increased, and therefore the second transparent layer 14 having a sufficiently high hardness with brittleness being more mitigated can be obtained. When the mass ratio is smaller than 20%, crosslink density is not too low compared with the case of smaller than 20%, and therefore the second transparent layer 14 becomes sufficiently hardness. Also, when the mass ratio is equal to or smaller than 90%, crosslink density is not too high compared with the case of exceeding 90%. For this reason, the second transparent layer 14 with excellent flexibility and without brittleness can be more reliably obtained.

[Acid Water]

Acid water as a third component of the coating liquid preferably has a hydrogen ion exponent (pH) equal to or larger than 2 and equal to or higher than 5, more preferably equal to or larger than 2.5 and equal to or higher than 5.5. If pH is smaller than 2 or larger than 6, when tetraalkoxysilane and an organosilicon compound represented by General Formula (1) are mixed in this acid water to obtain an aqueous solution, after alkoxysilan is hydrolyzed in this aqueous solution, that is, an alkoxysilan aqueous solution, to yield silanol, silanol proceed to be condensed, and the viscosity of this aqueous solution tends to increase. Note that the pH value described above is a value at 25° C., which is a so-called “ambient temperature”.

The acid water is obtained by dissolving organic acid or inorganic acid in water. Acid is not particularly restrictive, but organic acids such as acetic acid, propionic acid, formic acid, fumaric acid, maleic acid, oxalic acid, malonic acid, succinic acid, citric acid, malic acid, and ascorbic acid and inorganic acids such as hydrochloric acid, nitric acid, sulfuric acid, phosphoric acid, and boric acid can be used. Among these, acetic acid is preferable in view of ease of handling.

The alkoxysilane is prepared so that the amount of acid water is in a range equal to or larger than 60 parts by mass and equal to or smaller than 2000 parts by mass when a total amount of tetraalkoxysilane and the organosilicon compound represented by General Formula (1), that is, the amount of alkoxysilan used, is taken as 100 parts by mass. With this composition, a hydrolytic aqueous solution of alkoxysilane with excellent hydrolyzability and stability of yielded silanol can be obtained. The coating fluid for the second transparent layer obtained by using this hydrolytic aqueous solution of alkoxysilane, that is, a silanol aqueous solution, is excellent in stability even it is water-based. Thus, the storage time until the start of producing the optical laminate films 10 and 20 is less restrictive, and there is no need to change the producing conditions at continuous production of the optical laminate films 10 and 20 according to changes in properties of the coating fluid for hard coat. The amount of acid water is more preferably in a range equal to or larger than 100 parts by mass and equal to or smaller than 1500 parts by mass with respect to the total amount of tetraalkoxysilane and the organosilicon compound represented by General Formula (1) of 100 parts by mass, particularly preferably in a range equal to or larger than 150 parts by mass and equal to or smaller than 1200 parts by mass. If acid water is smaller than 60 parts by mass with respect to the 100 parts by mass alkoxysilane, silanol yielded by hydrolyzing alkoxysilane is dehydrated and condensed to make the aqueous solution prone to be gelated. With 60 parts or more by mass, this gelation can be reliably suppressed. On the other hand, if acid water is equal to or smaller than 2000 parts by mass, the concentration of alkoxysilane in the coating fluid is high, and therefore the amount of coating for forming a sufficient thickness of the second transparent layer 14 does not become too much, compared with the case of exceeding 2000 parts by mass. Therefore, it is possible to reliably prevent unevenness in thickness of the coating fluid for the second transparent layer and a protracted time of drying the coating.

Note that a silane compound different from tetraalkoxysilane and the organosilicon compound represented by General Formula (1) can be used as the coating fluid for the second transparent layer. In this case, these components are preferably mixed so that acid water is in a range equal to or smaller than 60 parts by mass and equal to or smaller than 2000 parts by mass with respect to 100 parts by mass a total amount of tetraalkoxysilane and the organosilicon compound represented by General Formula (1) and the other silane compound.

<Colloidal Silica>

As a fourth component, colloidal silica may be contained in the coating fluid for the second transparent layer. This colloidal silica is a colloid in which silicon dioxide or its hydrate is dispersed in water, and colloid particles have an average particle diameter in a range of 3 nm to 50 nm. With the average particle diameter of the colloid particles being equal to or larger than 3 nm, viscosity of the coating fluid for the second transparent layer is not too high, and therefore addition of colloidal silica does not restrict the coating conditions, and the second transparent layer 14 can be formed harder. Also, with the average particle diameter of the colloid particles being equal to or smaller than 50 nm, scattering of incident light to the second transparent layer 14 is not too large, and therefore transparency of the optical laminate films 10 and 20 are not impaired. The average particle diameter of the colloid particles is preferably in a range of 4 nm to 50 nm, more preferably in a range of 4 nm to 40 nm, and particularly preferably in a range of 5 nm to 35 nm.

Note that pH of colloidal silica at the time of being added to the coating fluid for the second transparent layer is more preferably adjusted in a range equal to or larger than 2 and equal to or smaller than 7. If this pH is equal to or larger than 2 and equal to or smaller than 7, stability of silanol, which is a hydrolysate of alkoxysilane, is better, and an increase in viscosity of the coating fluid due to quick dehydration and condensation of alkoxysilane can be more reliably suppressed, compared with the case in which pH is smaller than 2 or larger than 7.

The amount of colloidal silica is preferably in a range equal to or larger than 40 parts by mass and equal to or smaller than 200 parts by mass, and, more preferably in a range equal to or larger than 80 parts by mass and equal to or smaller than 150 parts by mass, with respect to 100 parts by mass a total amount of tetraalkoxysilane and the organosilicon compound represented by General Formula (1). When the amount of colloidal silica is smaller than 40 parts by mass, a volume shrinkage ratio due to dehydration and condensation at the time of heating and curing is increased to possibly cause a crack in the cured film. With the amount being equal to or larger than 40 parts by mass, this crack can be more reliably suppressed. Also, when the amount of addition of colloidal silica exceeds 200 parts by mass, brittleness of the film is increased, and a crack may occur by bending the optical laminate films 10 and 20. This phenomenon can be more reliably prevented by setting the amount equal to or smaller than 200 parts by mass.

<Curing Agent>

A curing agent as a fifth component of the coating fluid is preferably soluble in water. The curing agent promotes dehydration and condensation of silanol to facilitate formation of a siloxane bond. As a water-soluble curing agent, a water-soluble inorganic acid, organic acid, salt of an organic acid, salt of an inorganic acid, metal alkoxide, or metal complex can be used.

Preferable examples of inorganic acid include boric acid, phosphoric acid, hydrochloric acid, nitric acid, and sulfuric acid.

Preferable examples of organic acid include acetic acid, formic acid, oxalic acid, citric acid, malic acid, and ascorbic acid.

Preferable examples of salt of organic acid include aluminum acetate, aluminum oxalate, zinc acetate, zinc oxalate, magnesium acetate, magnesium oxalate, zirconium acetate, and zirconium oxalate.

Preferable examples of salt of inorganic acid include aluminum chloride, aluminum sulfate, aluminum nitrate, zinc chloride, zinc sulfate, zinc nitrate, magnesium chloride, magnesium sulfate, magnesium nitrate, zirconium chloride, zirconium sulfate, and zirconium nitrate.

Preferable examples of the metal alkoxide include aluminum alkoxide, titanium alkoxide, and zirconium alkoxide.

Preferable examples of metal complex include aluminum acetylacetonate, aluminum ethylacetonate, titanium acetylacetonate, and titanium ethylacetoacetate.

Among the above-described curing agents, in particular, compounds containing boron, such as boric acid, phosphoric acid, aluminum alkoxide, and aluminum acetylacetonate, compounds containing phosphorus, and compounds containing aluminum are preferable in view of stability in water. Among these, at least any one type can be used as the curing agent.

The curing agent is preferably uniformly mixed and dissolved in the coating fluid, and dissolving the curing agent in water as a solvent for the coating fluid for the second transparent layer in the present invention is preferable in ensuring transparency of the second transparent layer 14. If solubility in water is low, the curing agent is present as a solid in the coating fluid, and therefore it remains as a foreign substance even after coating and drying and, in some cases, the second transparent layer 14 may have low transparency.

The amount of the curing agent is preferably in a range from 0.1 parts by mass or larger to 20 parts by mass or smaller with respect to 100 parts by mass of all alkoxysilane containing tetraalkoxysilane and the organosilicon compound represented by General Formula (1) and, more preferably in a range from 0.5 parts by mass or larger to 10 parts by mass or smaller, and a range from 1 part by mass or larger to 8 parts by mass or smaller is particularly preferable.

<Other Additives>

To control the surface characteristics, in particular, coefficients of friction, of the optical laminate films 10 and 20, the coating fluid for the second transparent layer may contain a wax.

As a wax, paraffin wax, microwax, polyethylene wax, polyester-based wax, carnauba wax, fatty acid, fatty amide, metallic soap, or others can be used.

Also, the coating fluid for the second transparent layer may contain a surface active agent. By using the surface active agent, surface tension of the coating fluid for the second transparent layer is decreased, coating unevenness of the coating fluid for the second transparent layer with respect to the first transparent layer 13 is suppressed, and the second transparent layer 14 having a uniform thickness can be formed on the first transparent layer 13. The surface active agent is not particularly restrictive, and any of aliphatic, aromatic, and fluorine-based surface active agents may be used, and any of nonion-based, anion-based, and cation-based surface active agents may be used.

[Translucent Particles]

In the present embodiment, a particle having a primary particle diameter equal to or larger than 100 nm is defined as a translucent particle. When the diameter is smaller than 100 nm, the particle is substantially transparent in a binder and does not achieve a diffusion function.

Examples of at least two types of translucent particles include organic rein fine particle and inorganic resin particles. Examples of these particles include silica, calcium carbonate, magnesium carbonate, barium sulfate, polystyrene, polystyrene-divinylbenzene copolymer polymethylmethacrylate, crosslinked polymethylmethacrylate, styrene/acrylic copolymer, melamine, and benzoguanamine. Preferably, particles of at least one type selected from the following group are used: melamine resin particles, hollow particles, polystyrene resin particles, and styrene/acrylic copolymer resin particles, and silicone resin particles.

The volume average particle diameter r of the translucent particles of at least two types is preferably equal to or larger than 1.0 μm and equal to or smaller than 3.0 μm.

The volume average particle diameter r of all of the translucent particles of at least two types satisfies r/4≦t<r with respect to an average film thickness t of the transparent layer. The total sum S of all of the translucent particles satisfies 30 mg/m²≦S≦500 mg/m². If the total sum S is smaller than 30 mg/m², it is disadvantageously difficult to mitigate rainbow-like unevenness. If the total sum S is larger than 500 mg/m², the amount of particles is too much, and powder removal disadvantageously occurs due to missing or falling of particles. Therefore, by setting the range as described above, stable production can be made while rainbow-like unevenness are suppressed.

For the translucent particles, two or more types of particles having different particle diameters are mixed together for use. In particular, among two or more types of translucent particles, when a difference between at least two types in volume average particle diameter is larger than 1 μm, coagulation of particles is decreased. With this, the outer appearance of the film surface is improved.

Also, translucent particles of two or more different materials are preferably used at the same time. For example, by changing the refractive index of each type of the particles, luminance and mitigation of rainbow-like unevenness can be balanced, or the outer appearance of the film surface can be improved.

[Easily-Adhesive Layer]

The easily-adhesive layer 12 is provided on one surface of the support 11 in order to improve bondability of the support 11 to the prism layer 17 and increase adhesiveness to the prism layer 17.

The easily-adhesive layer 12 is normally formed by applying a coating fluid made of a binder, a curing agent, and a surface active agent onto the one surface of the support 11. As the material for use as the easily-adhesive layer 12, a suitable material is preferably selected for the purpose of increasing adhesiveness to the prism layer 17. Also, organic or inorganic fine particles may be contained in the easily-adhesive layer 12 as appropriate.

The binder used for the easily-adhesive layer 12 is not particularly restrictive. However, in view of adhesiveness, at least one of polyester, polyurethane, acrylic resin, and styrene-butadiene copolymer is preferable. Also, a water-soluble or water-dispersive binder is particularly preferable in view of less load on the environment.

The easily-adhesive layer 12 may include metal oxide particles exhibiting conductivity by electron conduction. As the metal oxide particles, general metal oxides can be used, and examples include ZnO, TiO₂, SnO₂, Al₂O₃, In₂O₃, MgO, BaO, MoO₃, and composite oxides thereof, and these metal oxides may contain a small amount of any different element. Among these metal oxides, SnO₂, ZnO, TiO₂, and In₂O₃ are preferable, and SnO₂ is particularly preferable. In place of the metal oxide particles exhibiting conductivity by electron conduction, a π electron-conjugated conductive polymer may be contained, such as a polythiophene-based polymer.

By adding metal oxide particles exhibiting conductivity by electron conduction or a π electron-conjugated conductive polymer to the easily-adhesive layer 12, the surface resistance of the easily-adhesive layer 12 is adjusted to be equal to or lower than 10¹²Ω/sq. With this, sufficient antistatic prevention can be achieved, thereby preventing absorption of dust and dirt onto the optical laminate films 10 and 20.

Fine particles made of metal oxide may be contained in the easily-adhesive layer 12 in order to adjust the refractive index of the easily-adhesive layer 12. As the metal oxide, metal oxide with a high refractive index is preferable, such as tin oxide, zirconium oxide, zinc oxide, titanium oxide, cerium oxide, or niobium oxide because metal oxide with a high refractive index can change the refractive index even with a small amount. The particle diameter of the fine particles made of metal oxide is preferably in a range of 1 nm to 50 nm, and particularly preferably in a range of 2 nm to 40 nm. Although the amount of the fine particles of metal oxide can be determined according to a target refractive index, the fine particles are preferably contained in the easily-adhesive layer 12 so that the mass of the fine particles is in a range of 10 to 90 when the total mass of the translucent resin is assumed to be 100, and particularly preferably in a range of 30 to 80.

The thickness of the easily-adhesive layer 12 can be controlled by adjusting the amount of coating of the coating fluid forming the easily-adhesive layer 12. To exhibit excellent adhesiveness with highly transparency, the thickness is more preferable constant in a range of 0.01 μm to 5 μm. With the thickness being equal to or larger than 0.01 μm, adhesiveness can be more reliably improved compared with the case in which the thickness is smaller than 0.01 μm. With the thickness being equal to or smaller than 5 μm, the easily-adhesive layer 12 having a more uniform thickness can be formed, compared with the case in which the thickness is larger than 5 μm. Furthermore, an increase in the amount of use of the coating fluid can be suppressed to prevent a protracted drying time, thereby suppressing an increase in cost. More preferably, the range of thickness of the easily-adhesive layer 12 is 0.02 μm to 3 μm.

[Lens Layer]

As a lens layer, a microlens layer, a prism layer, a lenticular lens layer, or others can be used. Among these, in particular, the prism layer is suitably used.

The prism layer 17 is formed by an embossing method or a cast polymerizing method. Normally, the cast polymerizing method with productivity higher than the embossing method is used.

In the cast polymerizing method, a film made of an UV-curable compound cured with ultraviolet rays (UV) is formed in a predetermined shape. With this shape being kept, the compound is cured with UV, thereby forming a plurality of columns of prisms having a predetermined sectional shape as the prism layer 17. When the prism layer 17 is formed by the cast polymerizing method, a material having a monomer, an oligomer, or a polymer with a double bond of radical polymerization as a main component is generally used and, furthermore, a polymerization initiator is contained. Examples of a monomer or an oligomer with a double bond of radical polymerization include an acrylic monomer and an acrylic oligomer. In view of mass productivity, the cast polymerizing method is more preferable than the embossing method and, a cast polymerizing method using an UV-curable compound is particularly preferable.

The prism layer 17 is formed on the easily-adhesive layer 12 of the support 11 in a subsequent process. Thus, in the optical laminate films 10 and 20, when light enters from the transparent layer 16 side, transmittance of light having a wavelength of 340 nm of incident light is preferably in a range equal to or larger than 70% and equal to or smaller than 100%. With this, the subsequent process for providing the prism layer 17 can be shortened as ever.

In general, a metal halide lamp for UV curing has a main luminous wavelength in a range of 340 nm to 400 nm, and the main luminous wavelength of a high-pressure mercury-vapor lamp is 365 nm. Also, the transmittance of an optical laminate film requiring transparency in a visible-light area tends to be decreased in the range of 340 nm to 400 nm as the wavelength is shorter. Therefore, the transmittance of light of at least 340 nm is preferably 70% to 100%. In particular, the transmittance of light is preferably 70% to 100% in the entire range of 340 nm to 400 nm. If the transmittance of light having a wavelength of 340 nm is smaller than 70%, when the prism layer 17 is provided on one surface of the support 11 by UV cuing, UV light emitted by using a metal halide lamp or a high-pressure mercury-vapor lamp is absorbed in the optical laminate films 10 and 20. With this absorption, the strength of UV light that can contribute to curing for forming the prism layer 17 is decreased. As a result, efficiency of curing the prism layer 17 is degraded. When efficiency of curing is degraded, the curing time is required to be extended until the layer becomes in a predetermined cured state, thereby decreasing productivity of optical films. Also, when the curing time is not desired to be extended, curing of the prism layer 17 is insufficient, and therefore the prism layer 17 is insufficient in anti-damage properties.

In both of the optical laminate films 10 and 20, when light enters from the transparent layer 16 side, transmittance of light having a wavelength of 365 nm of incident light is more preferably in a range equal to or larger than 76% and equal to or smaller than 100%. This is particularly effective when a high-pressure mercury-vapor lamp is used as a light source of radiation light for use in forming the prism layer 17, because an emission line of the high-pressure mercury-vapor lamp is of light of 365 nm.

### EXAMPLES

The present invention is described in more detail below with reference to examples and comparative examples of the present invention. However, these are not meant to be restrictive.

### First Example

### Support

Polyethylene terephthalate (hereinafter referred to as “PET”) resin having an intrinsic viscosity of 0.66 subjected to polycondensation with a Ti compound as a catalyst was dried so as to have a water content equal to or smaller than 50 ppm, and was dissolved in an extruder with a heater temperature being set at 280° C. to 300° C. The dissolved PET resin was discharged from a die part onto an electrostatically-charged chill roll to obtain an amorphous base. The obtained amorphous base was drawn by a factor of 3.1 in a base running direction and then by a factor of 3.8 in a width direction to obtain a PET support having a thickness of 250 μm.

[Easily-Adhesive Layer]

The PET support (having a refractive index of 1.66) had one surface subjected to corona discharge process, and a coating fluid for the easily-adhesive layer formed of the composition described below was applied onto the support by the bar coat method. The amount of coating was 9.75 cc/m², and drying was performed at 145° C. for one minute. With this, the easily-adhesive layer having a thickness of approximately 0.8 μm was formed on the support.

[Coating Fluid 1 for Easily-Adhesive Layer]

| | |
|---|---|
| Polyester resin binder | 124.0 parts by mass |
| (Manufactured by Goo Chemical Co., Ltd., | |
| Plascoat Z-687, solid content of 25%) | |
| Polyester resin binder | 106.9 parts by mass |
| (Manufactured by DIC Corporation, | |
| Finetex FS-650, solid content of 29%) | |
| Acrylic resin binder | 0.8 parts by mass |
| (Manufactured by Daicel Chemical Industries | |
| Ltd., EM48D, solid content of 27.5%) | |
| Compound having a plurality of carbodiimide | 31.0 parts by mass |
| structures | |
| (Manufactured by Nisshinbo Chemical, Inc., | |
| CARBODILITE V-02-L2, solid content of 40%) | |
| Oxazoline compound | 69.9 parts by mass |
| (Manufactured by Nippon Shokubai Co., | |
| Ltd., EPOCLOTH K2020E, solid content of 40%) | |
| Surface active agent A | 12.3 parts by mass |
| (Manufactured by NOF Corporation, | |
| 1% aqueous solution of Rapizol B-90, anionic) | |
| Surface active agent B | 29.7 parts by mass |
| (Manufactured by Sanyo Chemical Industries, | |
| Ltd., 1% aqueous solution of Naroacty | |
| CL-95, nonionic) | |
| PMMA spherical particles | 0.7 parts by mass |
| (Manufactured by Soken Chemical & | |
| Engineering Co., Ltd., water dispersion of | |
| MR-2G, solid content of 15%) | |
| Lubricant | 3.3 parts by mass |
| (Manufactured by Chukyo Yushi Co., Ltd., | |
| Serosol of carnauba wax dispersion, solid | |
| content of 30%) | |
| Preservative | 1.1 parts by mass |
| (Manufactured by Daito Chemical Co., Ltd., | |
| AF-337, solid content of 3.5%, methanol | |
| solvent) | |
| Distilled Water | added so as to |
| | achieve 1000 parts |
| | by mass in total |

[First Transparent Layer]

After the easily-adhesive layer was formed on one surface of the support, the coating fluid 1 for the first transparent layer formed of the composition described below was applied onto the other surface by the bar coat method. The amount of coating was 8.4 cc/m², and drying was performed at 145° C. for one minute. With this, the first transparent layer having an average film thickness of approximately 0.1 μm was formed on a side opposite to the surface where the easily-adhesive layer was formed.

[Coating Fluid 1 for First Transparent Layer]

| | |
|---|---|
| Self-crosslinking polyurethane resin binder | 35.0 parts by mass |
| (Manufactured by Mitsui Chemicals Inc., | |
| TAKELAC WS-5100, solid content of 30%) | |
| Tin dioxide-antimony-combined acicular | 43.7 parts by mass |
| metal oxide water dispersion | |
| (Manufactured by Ishihara Sangyo Kaisha | |
| Ltd., FS-10D, solid content of 20%) | |
| Surface active agent C | 2.1 parts by mass |
| (Manufactured by Sanyo Chemical | |
| Industries, Ltd., 10% aqueous solution of | |
| Sanded BL, anionic) | |
| Surface active agent B | 21.0 parts by mass |
| (Manufactured by Sanyo Chemical | |
| Industries, Ltd., 1% aqueous solution of | |
| Naroacty CL-95, nonionic) | |
| Distilled Water | added so as to achieve 1000 |
| | parts by mass in total |

[Second Transparent Layer]

Subsequently, a coating fluid for the second transparent layer formed of the composition described below was applied onto the first transparent layer by the bar coat method. The amount of coating was 9.4 cc/m², and drying was performed at 145° C. for one minute. With this, the second transparent layer having an average film thickness of approximately 0.9 μm was formed.

[Coating Fluid for Second Transparent Layer]

| | |
|---|---|
| Acetic-acid aqueous solution | 136.0 parts by mass |
| (Manufactured by Daicel Chemical Industries | |
| Ltd., 1% aqueous solution of industrial | |
| acetic acid) | |
| 3-glycidoxypropyltrimethoxysilane | 53.2 parts by mass |
| (Manufactured by Shin-Etsu Chemical Co., | |
| Ltd., KBE-403) | |
| Tetramethoxysilane | 61.8 parts by mass |
| (Manufactured by Shin-Etsu Chemical Co., | |
| Ltd., KBE-04) | |
| Colloidal silica | 542.4 parts by mass |
| (Manufactured by Nissan Chemical Industries | |
| Co., Ltd., SNOWTEX OS, solid content of 20%) | |
| Curing agent | 1.8 parts by mass |
| (Manufactured by Kawaken Fine Chemical Co., | |
| Ltd., Alumichelate A (W)) | |
| Surface active agent C | 20.6 parts by mass |
| (Manufactured by Sanyo Chemical Industries, | |
| Ltd., 10% aqueous solution of Sanded BL, | |
| anionic) | |
| Surface active agent B | 60.0 parts by mass |
| (Manufactured by Sanyo Chemical Industries, | |
| Ltd., 1% aqueous solution of Naroacty | |
| CL-95, nonionic) | |
| Polystyrene resin fine particles | 6.2 parts by mass |
| (Manufactured by Soken Chemical & | |
| Engineering Co., Ltd., MP5000, average particle | |
| diameter of 0.4 μm, CV value of 10% to 15%) | |
| Polystyrene resin fine particles | 6.2 parts by mass |
| (Manufactured by Soken Chemical & | |
| Engineering Co., Ltd., SX130H, average particle | |
| diameter of 0.4 μm, CV value of 10% to 15%) | |
| Water-dispersing element of polystyrene | 31.2 parts by mass |
| resin fine particles | |
| (Manufactured by Zeon Corporation, | |
| Nippol UFN1008, solid content of 20%, average | |
| particle diameter of 1.9 μm, CV value of 5%) | |
| Distilled Water | added so as to achieve 1000 |
| | parts by mass in total |

Note that the coating fluid for the second transparent layer was prepared by the following method.

While the acetic-acid aqueous solution was being heavily stirred, 3-glycidoxypropyltrimethoxysilane was dropped into this acetic-acid aqueous solution for three minutes. Subsequently, tetraalkoxysilane was added to the acetic-acid aqueous solution while being heavily stirred for five minutes, and then stirring continued for two hours (this aqueous solution is referred to as an X fluid).

The curing agent was added to colloidal silica, and stirring continued for two hours (this aqueous solution is referred to as a Y fluid).

Also, the surface active agent, distilled water, and resin particles were added, and ultrasonic dispersion was performed for five minutes (this particle dispersion fluid is referred to as a Z fluid). The Y fluid, the surface active agent, the Z fluid, and distilled water were sequentially added to the X fluid.

[Prism Layer]

After the easily-adhesive layer and the first and second transparent layers were formed, a coating fluid for a prism layer described below was applied onto an easily-adhesive layer side by the bar coat method with a #24 bar. Then, after drying was performed at 60° C. for three minutes, a mold having a prism layer pattern molded thereon was pressed onto a prism layer coating surface, which was radiated with UV light (a metal halide lamp UVL-1500M2 manufactured by Ushio Inc.) from a support side on a condition of 2000 mJ/cm², thereby curing the resin. By peeling off the support from the mold, a prism layer having a vertical angle of 90° C., a pitch of 50 μm, and a height of 28 μm was formed.

[Prism-Layer Coating Fluid]

| | |
|---|---|
| Compound represented by Chemical Formula 1 below | 34.3 parts by mass |
| Compound represented by Chemical Formula 2 below | 13.7 parts by mass |
| Compound represented by Chemical Formula 3 below | 13.7 parts by mass |
| Compound represented by Chemical Formula 4 below | 6.9 parts by mass |
| Compound represented by Chemical Formula 5 below | 1.4 parts by mass |
| Methyl ethyl ketone | 15.0 parts by mass |
| Propyleneglycolmonomethylacetate | 15.0 parts by mass |

[Chemical Formula 1] 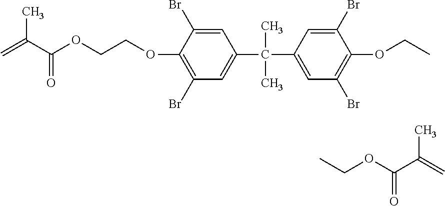
[Chemical Formula 2] 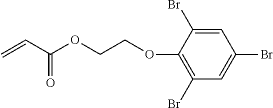
[Chemical Formula 3] 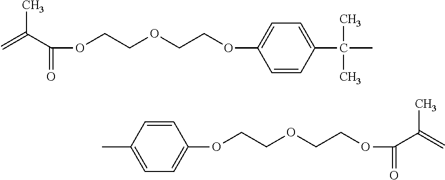
[Chemical Formula 4] 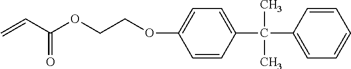
[Chemical Formula 5]

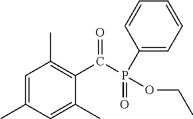

### Second Example

As a coating fluid for the second transparent layer, in place of the one in the first example, a coating fluid for the second transparent layer formed of the composition described below was subsequently applied onto the first transparent layer by the bar coat method. The amount of coating was 7.8 cc/m², and drying was performed at 145° C. for one minute. With this, the second transparent layer having an average film thickness of approximately 0.9 μm was formed.

[Coating Fluid for Second Transparent Layer]

| | |
|---|---|
| Acetic-acid aqueous solution | 136.0 parts |
| (Manufactured by Daicel Chemical Industries Ltd., 1% | by mass |
| aqueous solution of industrial acetic acid) | |
| 3-glycidoxypropyltrimethoxysilane | 53.2 parts |
| (Manufactured by Shin-Etsu Chemical Co., Ltd., | by mass |
| KBE-403) | |
| Tetramethoxysilane | 61.8 parts |
| (Manufactured by Shin-Etsu Chemical Co., Ltd., | by mass |
| KBE-04) | |
| Colloidal silica | 542.4 parts |
| (Manufactured by Nissan Chemical Industries Co., Ltd., | by mass |
| SNOWTEX OS, solid content of 20%) | |
| Curing agent | 1.8 parts |
| (Manufactured by Kawaken Fine Chemical Co., Ltd., | by mass |
| Alumichelate A (W)) | |
| Surface active agent C | 20.6 parts |
| (Manufactured by Sanyo Chemical Industries, Ltd., | by mass |
| 10% aqueous solution of Sanded BL, anionic) | |
| Surface active agent B | 60.0 parts |
| (Manufactured by Sanyo Chemical Industries, Ltd., 1% | by mass |
| aqueous solution of Naroacty CL-95, nonionic) | |
| Acrylic resin fine particles | 4.3 parts |
| (Manufactured by Soken Chemical & Engineering Co., | by mass |
| Ltd., MX-80H3WT, average particle diameter | |
| of 0.8 μm, CV value of 9%) | |
| Acrylic resin fine particles | 4.3 parts |
| (Manufactured by Soken Chemical & Engineering Co., | by mass |
| Ltd., MX-150, average particle diameter of 1.5 μm, CV | |
| value of 9%) | |
| Acrylic resin fine particles | 4.3 parts |
| (Manufactured by Soken Chemical & Engineering Co., | by mass |
| Ltd., MX-180, average particle diameter of 2.0 μm, CV | |
| value of 9%) | |
| Distilled Water | added so as to |
| | achieve 1000 |
| | parts by mass |
| | in total |

### Third Example

As a coating fluid for the second transparent layer, in place of the one in the first example, a coating fluid for the second transparent layer formed of the composition described below was subsequently applied on the first transparent layer by the bar coat method. The amount of coating was 10.4 cc/m², and drying was performed at 145° C. for one minute. With this, the second transparent layer having an average film thickness of approximately 1.0 μm was formed.

[Coating Fluid for Second Transparent Layer]

| | |
|---|---|
| Acetic-acid aqueous solution | 122.5 parts |
| (Manufactured by Daicel Chemical Industries Ltd., 1% | by mass |
| aqueous solution of industrial acetic acid) | |
| 3-glycidoxypropyltrimethoxysilane | 48.0 parts |
| (Manufactured by Shin-Etsu Chemical Co., Ltd., KBE-403) | by mass |
| Tetramethoxysilane | 55.6 parts |
| (Manufactured by Shin-Etsu Chemical Co., Ltd., KBE-04) | by mass |
| Colloidal silica | 488.9 parts |
| (Manufactured by Nissan Chemical Industries Co., Ltd., | by mass |
| SNOWTEX OS, solid content of 20%) | |
| Curing agent | 1.6 parts |
| (Manufactured by Kawaken Fine Chemical Co., Ltd., | by mass |
| Alumichelate A (W)) | |
| Surface active agent C | 18.6 parts |
| (Manufactured by Sanyo Chemical Industries, Ltd., 10% | by mass |
| aqueous solution of Sanded BL, anionic) | |
| Surface active agent B | 60.2 parts |
| (Manufactured by Sanyo Chemical Industries, Ltd., 1% | by mass |
| aqueous solution of Naroacty CL-95, nonionic) | |
| Acrylic resin fine particles | 7.2 parts |
| (Manufactured by Soken Chemical & Engineering Co., | by mass |
| Ltd., MX80H3WT, average particle diameter of 0.8 μm, | |
| CV value of 9%) | |
| Polystyrene resin fine particles | 7.2 parts |
| (Manufactured by Soken Chemical & Engineering Co., | by mass |
| Ltd., SX130H, average particle diameter of 1.3 μm, CV | |
| value of 9%) | |
| Water-dispersing element of polystyrene resin fine particles | 36.0 parts |
| (Manufactured by Zeon Corporation, Nippol UFN1008, | by mass |
| solid content of 20%, average particle diameter of 1.9 μm, | |
| CV value of 5%) | |
| Distilled Water | added so as to |
| | achieve 1000 |
| | parts by mass |
| | in total |

### Fourth Example

As a coating fluid for the second transparent layer, in place of the one in the first example, a coating fluid for the second transparent layer formed of the composition described below was subsequently applied on the first transparent layer by the bar coat method. The amount of coating was 10.4 cc/m², and drying was performed at 145° C. for one minute. With this, the second transparent layer having an average film thickness of approximately 1.0 μm was formed.

[Coating Fluid for Second Transparent Layer]

| | |
|---|---|
| Acetic-acid aqueous solution | 122.5 parts |
| (Manufactured by Daicel Chemical Industries Ltd., 1% | by mass |
| aqueous solution of industrial acetic acid) | |
| 3-glycidoxypropyltrimethoxysilane | 48.0 parts |
| (Manufactured by Shin-Etsu Chemical Co., Ltd., KBE-403) | by mass |
| Tetramethoxysilane | 55.6 parts |
| (Manufactured by Shin-Etsu Chemical Co., Ltd., KBE-04) | by mass |
| Colloidal silica | 488.9 parts |
| (Manufactured by Nissan Chemical Industries Co., Ltd., | by mass |
| SNOWTEX OS, solid content of 20%) | |
| Curing agent | 1.6 parts |
| (Manufactured by Kawaken Fine Chemical Co., Ltd., | by mass |
| Alumichelate A (W)) | |
| Surface active agent C | 18.6 parts |
| (Manufactured by Sanyo Chemical Industries, Ltd., 10% | by mass |
| aqueous solution of Sanded BL, anionic) | |
| Surface active agent B | 60.2 parts |
| (Manufactured by Sanyo Chemical Industries, Ltd., 1% | by mass |
| aqueous solution of Naroacty CL-95, nonionic) | |
| Acrylic resin fine particles | 7.2 parts |
| (Manufactured by Soken Chemical & Engineering Co., | by mass |
| Ltd., MX80H3WT, average particle diameter of 0.8 μm, | |
| CV value of 9%) | |
| Acrylic resin fine particles | 7.2 parts |
| (Manufactured by Soken Chemical & Engineering Co., | by mass |
| Ltd., MX150, average particle diameter of 1.5 μm CV | |
| value of 9%) | |
| Water-dispersing element of polystyrene resin fine particles | 36.0 parts |
| (Manufactured by Zeon Corporation, Nippol UFN1008, | by mass |
| solid content of 20%, average particle diameter of 1.9 μm, | |
| CV value of 5%) | |
| Distilled Water | added so as to |
| | achieve 1000 |
| | parts by mass |
| | in total |

### Fifth Example

As a coating fluid for the second transparent layer, in place of the one in the first example, a coating fluid for the second transparent layer formed of the composition described below was subsequently applied on the first transparent layer by the bar coat method. The amount of coating was 10.4 cc/m², and drying was performed at 145° C. for one minute. With this, the second transparent layer having an average film thickness of approximately 1.0 μm was formed.

[Coating Fluid for Second Transparent Layer]

| | |
|---|---|
| Acetic-acid aqueous solution | 122.5 parts |
| (Manufactured by Daicel Chemical Industries Ltd., 1% | by mass |
| aqueous solution of industrial acetic acid) | |
| 3-glycidoxypropyltrimethoxysilane | 48.0 parts |
| (Manufactured by Shin-Etsu Chemical Co., Ltd., KBE-403) | by mass |
| Tetramethoxysilane | 55.6 parts |
| (Manufactured by Shin-Etsu Chemical Co., Ltd., KBE-04) | by mass |
| Colloidal silica | 488.9 parts |
| (Manufactured by Nissan Chemical Industries Co., Ltd., | by mass |
| SNOWTEX OS, solid content of 20%) | |
| Curing agent | 1.6 parts |
| (Manufactured by Kawaken Fine Chemical Co., Ltd., | by mass |
| Alumichelate A (W)) | |
| Surface active agent C | 18.6 parts |
| (Manufactured by Sanyo Chemical Industries, Ltd., 10% | by mass |
| aqueous solution of Sanded BL, anionic) | |
| Surface active agent B | 60.2 parts |
| (Manufactured by Sanyo Chemical Industries, Ltd., 1% | by mass |
| aqueous solution of Naroacty CL-95, nonionic) | |
| Acrylic resin fine particles | 1.0 part |
| (Manufactured by Soken Chemical & Engineering Co., Ltd., | by mass |
| MX80H3WT, average particle diameter of 0.8 μm, CV | |
| value of 9%) | |
| Polystyrene resin fine particles | 1.0 part |
| (Manufactured by Soken Chemical & Engineering Co., Ltd., | by mass |
| SX130H, average particle diameter of 1.3 μm, CV | |
| value of 9%) | |
| Water-dispersing element of polystyrene resin fine particles | 19.0 parts |
| (Manufactured by Zeon Corporation, Nippol UFN1008, | by mass |
| solid content of 20%, average particle diameter of 1.9 μm, | |
| CV value of 5%) | |
| Distilled Water | added so as to |
| | achieve 1000 |
| | parts by mass |
| | in total |

### Sixth Example

As a coating fluid for the second transparent layer, in place of the one in the first example, a coating fluid for the second transparent layer formed of the composition below was subsequently applied on the first transparent layer by the bar coat method. The amount of coating was 9.5 cc/m², and drying was performed at 145° C. for one minute. With this, the second transparent layer having an average film thickness of approximately 1.1 μm was formed.

[Coating Fluid for Second Transparent Layer]

| | |
|---|---|
| Acetic-acid aqueous solution | 136.0 parts |
| (Manufactured by Daicel Chemical Industries Ltd., 1% | by mass |
| aqueous solution of industrial acetic acid) | |
| 3-glycidoxypropyltrimethoxysilane | 53.2 parts |
| (Manufactured by Shin-Etsu Chemical Co., Ltd., KBE-403) | by mass |
| Tetramethoxysilane | 61.8 parts |
| (Manufactured by Shin-Etsu Chemical Co., Ltd., KBE-04) | by mass |
| Colloidal silica | 542.4 parts |
| (Manufactured by Nissan Chemical Industries Co., Ltd., | by mass |
| SNOWTEX OS, solid content of 20%) | |
| Curing agent | 1.8 parts |
| (Manufactured by Kawaken Fine Chemical Co., Ltd., | by mass |
| Alumichelate A (W)) | |
| Surface active agent C | 20.6 parts |
| (Manufactured by Sanyo Chemical Industries, Ltd., 10% | by mass |
| aqueous solution of Sanded BL, anionic) | |
| Surface active agent B | 60.0 parts |
| (Manufactured by Sanyo Chemical Industries, Ltd., 1% | by mass |
| aqueous solution of Naroacty CL-95, nonionic) | |
| Acrylic resin fine particles | 26.4 parts |
| (Manufactured by Soken Chemical & Engineering Co., Ltd., | by mass |
| MX-80H3WT, average particle diameter of 0.8 μm, CV | |
| value of 9%) | |
| Acrylic resin fine particles | 26.4 parts |
| (Manufactured by Soken Chemical & Engineering Co., Ltd., | by mass |
| MX-180, average particle diameter of 2.0 μm, CV | |
| value of 9%) | |
| Distilled Water | added so as to |
| | achieve 1000 |
| | parts by mass |
| | in total |

### First Comparative Example

As a coating fluid for the second transparent layer, in place of the one in the first example, a coating fluid for the second transparent layer formed of the composition described below was subsequently applied on the first transparent layer by the bar coat method. The amount of coating was 7.1 cc/m², and drying was performed at 145° C. for two minutes. With this, the second transparent layer having an average film thickness of approximately 0.7 μm was formed.

[Coating Fluid for Second Transparent Layer]

| | |
|---|---|
| Acetic-acid aqueous solution | 136.0 parts |
| (Manufactured by Daicel Chemical Industries Ltd., 1% | by mass |
| aqueous solution of industrial acetic acid) | |
| 3-glycidoxypropyltrimethoxysilane | 53.2 parts |
| (Manufactured by Shin-Etsu Chemical Co., Ltd., KBE-403) | by mass |
| Tetramethoxysilane | 61.8 parts |
| (Manufactured by Shin-Etsu Chemical Co., Ltd., KBE-04) | by mass |
| Colloidal silica | 542.4 parts |
| (Manufactured by Nissan Chemical Industries Co., Ltd., | by mass |
| SNOWTEX OS, solid content of 20%) | |
| Curing agent | 1.8 parts |
| (Manufactured by Kawaken Fine Chemical Co., Ltd., | by mass |
| Alumichelate A (W)) | |
| Surface active agent C | 20.6 parts |
| (Manufactured by Sanyo Chemical Industries, Ltd., 10% | by mass |
| aqueous solution of Sanded BL, anionic) | |
| Surface active agent B | 60.0 parts |
| (Manufactured by Sanyo Chemical Industries, Ltd., 1% | by mass |
| aqueous solution of Naroacty CL-95, nonionic) | |
| Acrylic resin fine particles | 3.6 parts |
| (Manufactured by Soken Chemical & Engineering Co., Ltd., | by mass |
| MX-150, average particle diameter of 1.5 μm, CV | |
| value of 9%) | |
| Distilled Water | added so as to |
| | achieve 1000 |
| | parts by mass |
| | in total |

### Second Comparative Example

As a coating fluid for the second transparent layer, in place of the one in the first example, a coating fluid for the second transparent layer formed the composition described below was subsequently applied on the first transparent layer by the bar coat method. The amount of coating was 24.3 cc/m², and drying was performed at 145° C. for two minutes. With this, the second transparent layer having an average film thickness of approximately 2.3 μm was formed.

[Coating Fluid for Second Transparent Layer]

| | |
|---|---|
| Acetic-acid aqueous solution | 136.1 parts |
| (Manufactured by Daicel Chemical Industries Ltd., 1% | |
| aqueous solution of industrial acetic acid) | by mass |
| 3-glycidoxypropyltrimethoxysilane | 53.3 parts |
| (Manufactured by Shin-Etsu Chemical Co., Ltd., KBE-403) | by mass |
| Tetramethoxysilane | 61.8 parts |
| (Manufactured by Shin-Etsu Chemical Co., Ltd., KBE-04) | by mass |
| Colloidal silica | 543.1 parts |
| (Manufactured by Nissan Chemical Industries Co., Ltd., | by mass |
| SNOWTEX OS, solid content of 20%) | |
| Curing agent | 1.8 parts |
| (Manufactured by Kawaken Fine Chemical Co., Ltd., | by mass |
| Alumichelate A (W)) | |
| Surface active agent C | 20.6 parts |
| (Manufactured by Sanyo Chemical Industries, Ltd., 10% | by mass |
| aqueous solution of Sanded BL, anionic) | |
| Surface active agent B | 60.0 parts |
| (Manufactured by Sanyo Chemical Industries, Ltd., 1% | by mass |
| aqueous solution of Naroacty CL-95, nonionic) | |
| Acrylic resin fine particles | 29 parts |
| (Manufactured by Soken Chemical & Engineering Co., Ltd., | by mass |
| MX-300, average particle diameter of 3 μm, CV | |
| value of 9%) | |
| Distilled Water | added so as to |
| | achieve 1000 |
| | parts by mass |
| | in total |

### Third Comparative Example

As a coating fluid for the second transparent layer, in place of the one in the first example, a coating fluid for the second transparent layer formed of the composition described below was subsequently applied on the first transparent layer by the bar coat method. The amount of coating was 2.2 cc/m², and drying was performed at 145° C. for two minutes. With this, the second transparent layer having an average film thickness of approximately 0.2 μm was formed.

[Coating Fluid for Second Transparent Layer]

| | |
|---|---|
| Acetic-acid aqueous solution | 136.7 parts |
| (Manufactured by Daicel Chemical Industries Ltd., 1% | by mass |
| aqueous solution of industrial acetic acid) | |
| 3-glycidoxypropyltrimethoxysilane | 53.5 parts |
| (Manufactured by Shin-Etsu Chemical Co., Ltd., KBE-403) | by mass |
| Tetramethoxysilane | 62.1 parts |
| (Manufactured by Shin-Etsu Chemical Co., Ltd., KBE-04) | by mass |
| Colloidal silica | 545.3 parts |
| (Manufactured by Nissan Chemical Industries Co., Ltd., | by mass |
| SNOWTEX OS, solid content of 20%) | |
| Curing agent | 1.8 parts |
| (Manufactured by Kawaken Fine Chemical Co., Ltd., | by mass |
| Alumichelate A (W)) | |
| Surface active agent C | 20.6 parts |
| (Manufactured by Sanyo Chemical Industries, Ltd., 10% | by mass |
| aqueous solution of Sanded BL, anionic) | |
| Surface active agent B | 60.0 parts |
| (Manufactured by Sanyo Chemical Industries, Ltd., 1% | by mass |
| aqueous solution of Naroacty CL-95, nonionic) | |
| Acrylic resin fine particles | 32.0 parts |
| (Manufactured by Soken Chemical & Engineering Co., Ltd., | by mass |
| MX-150, average particle diameter of 1.5 μm, CV | |
| value of 9%) | |
| Distilled Water | added so as to |
| | achieve 1000 |
| | parts by mass |
| | in total |

### Fourth Comparative Example

As a coating fluid for the second transparent layer, in place of the one in the first example, a coating fluid for the second transparent layer formed of the composition described below was subsequently applied on the first transparent layer by the bar coat method. The amount of coating was 32.0 cc/m², and drying was performed at 145° C. for two minutes. With this, the second transparent layer having an average film thickness of approximately 8 μm was formed.

[Coating Fluid for Second Transparent Layer]

| | |
|---|---|
| Surface active agent | 1.8 parts |
| (Manufactured by Sanyo Chemical Industries, Ltd., | by mass |
| Naroacty CL-95) | |
| Polystyrene fine particles | 12.3 parts |
| (Manufactured by Sekisui Plastics Co., Ltd., SBX-4, | by mass |
| polystyrene particles, average particle diameter of 4 μm, | |
| CV value of 27%) | |
| Water-dispersing polymer | 708.0 parts |
| (polyurethane resin, manufactured by Mitsui Chemicals | by mass |
| Inc., TAKELAC W6010, solid content of 30%) | |
| Crosslinking agent | 44.2 parts |
| (Manufactured by Nisshinbo Chemical, Inc., | by mass |
| CARBODILITE V-02-L2, solid content of 40%) | |
| Distilled Water | added so as to |
| | achieve 1000 |
| | parts by mass |
| | in total |

This fluid was stirred for use after mixing.

### Fifth Comparative Example

As a coating fluid for the second transparent layer, in place of the one in the first example, a coating fluid for the second transparent layer formed of the composition described below was subsequently applied on the first transparent layer by the bar coat method. The amount of coating was 7.1 cc/m², and drying was performed at 145° C. for one minute. With this, the second transparent layer having an average film thickness of approximately 0.7 μm was formed.

[Coating Fluid for Second Transparent Layer]

| | |
|---|---|
| Acetic-acid aqueous solution | 148.3 parts |
| (Manufactured by Daicel Chemical Industries Ltd., 1% | by mass |
| aqueous solution of industrial acetic acid) | |
| 3-glycidoxypropyltrimethoxysilane | 58.1 parts |
| (Manufactured by Shin-Etsu Chemical Co., Ltd., KBE-403) | by mass |
| Tetramethoxysilane | 67.3 parts |
| (Manufactured by Shin-Etsu Chemical Co., Ltd., KBE-04) | by mass |
| Colloidal silica | 591.4 parts |
| (Manufactured by Nissan Chemical Industries Co., Ltd., | by mass |
| SNOWTEX OS, solid content of 20%) | |
| Curing agent | 2.0 parts |
| (Manufactured by Kawaken Fine Chemical Co., Ltd., | by mass |
| Alumichelate A (W)) | |
| Surface active agent C | 17.7 parts |
| (Manufactured by Sanyo Chemical Industries, Ltd., 10% | by mass |
| aqueous solution of Sanded BL, anionic) | |
| Surface active agent B | 52.0 parts |
| (Manufactured by Sanyo Chemical Industries, Ltd., 1% | by mass |
| aqueous solution of Naroacty CL-95, nonionic) | |
| Acrylic resin fine particles | 14.1 parts |
| (Manufactured by Soken Chemical & Engineering Co., Ltd., | by mass |
| MX-150, average particle diameter of 1.5 μm, CV | |
| value of 9%) | |
| Distilled Water | added so as to |
| | achieve 1000 |
| | parts by mass |
| | in total |

Note that the coating fluid for the second transparent layer was prepared by the following method.

While the acetic-acid aqueous solution was being heavily stirred, 3-glycidoxypropyltrimethoxysilane was dropped into this acetic-acid aqueous solution for three minutes. Subsequently, tetraalkoxysilane was added to the acetic-acid aqueous solution while being heavily stirred for five minutes, and then stirring continued for two hours (this aqueous solution is referred to as an X fluid).

The curing agent was added to colloidal silica, and stirring continued for two hours (this aqueous solution is referred to as a Y fluid).

Also, the surface active agent, distilled water, and resin particles were added, and ultrasonic dispersion was performed for five minutes (this particle dispersion fluid is referred to as a Z fluid). The Y fluid, the surface active agent, the Z fluid, and distilled water were sequentially added to the X fluid.

### Sixth Comparative Example

As a coating fluid for the second transparent layer, in place of the one in the first example, a coating fluid for the second transparent layer formed of the composition described below was subsequently applied on the first transparent layer by the bar coat method. The amount of coating was 7.8 cc/m², and drying was performed at 145° C. for one minute. With this, the second transparent layer having an average film thickness of approximately 0.8 μm was formed.

[Coating Fluid for Second Transparent Layer]

| | |
|---|---|
| Acetic-acid aqueous solution | 136.0 parts |
| (Manufactured by Daicel Chemical Industries Ltd., 1% | by mass |
| aqueous solution of industrial acetic acid) | |
| 3-glycidoxypropyltrimethoxysilane | 53.2 parts |
| (Manufactured by Shin-Etsu Chemical Co., Ltd., KBE-403) | by mass |
| Tetramethoxysilane | 61.8 parts |
| (Manufactured by Shin-Etsu Chemical Co., Ltd., KBE-04) | by mass |
| Colloidal silica | 542.4 parts |
| (Manufactured by Nissan Chemical Industries Co., Ltd., | by mass |
| SNOWTEX OS, solid content of 20%) | |
| Curing agent | 1.8 parts |
| (Manufactured by Kawaken Fine Chemical Co., Ltd., | by mass |
| Alumichelate A (W)) | |
| Surface active agent C | 20.6 parts |
| (Manufactured by Sanyo Chemical Industries, Ltd., 10% | by mass |
| aqueous solution of Sanded BL, anionic) | |
| Surface active agent B | 60.0 parts |
| (Manufactured by Sanyo Chemical Industries, Ltd., 1% | by mass |
| aqueous solution of Naroacty CL-95, nonionic) | |
| Acrylic resin fine particles | 1.1 parts |
| (Manufactured by Soken Chemical & Engineering Co., Ltd., | by mass |
| MX-80H3WT, average particle diameter of 0.8 μm, CV | |
| value of 9%) | |
| Acrylic resin fine particles | 1.1 parts |
| (Manufactured by Soken Chemical & Engineering Co., Ltd., | by mass |
| MX-150, average particle diameter of 1.5 μm, CV | |
| value of 9%) | |
| Acrylic resin fine particles | 1.1 parts |
| (Manufactured by Soken Chemical & Engineering Co., Ltd., | by mass |
| MX-180, average particle diameter of 2.0 μm, CV | |
| value of 9%) | |
| Distilled Water | added so as to |
| | achieve 1000 |
| | parts by mass |
| | in total |

### Seventh Comparative Example

As a coating fluid for the second transparent layer, in place of the one in the first example, a coating fluid for the second transparent layer formed of the composition described below was subsequently applied on the first transparent layer by the bar coat method. The amount of coating was 7.8 cc/m², and drying was performed at 145° C. for one minute. With this, the second transparent layer having an average film thickness of approximately 0.8 μm was formed.

[Coating Fluid for Second Transparent Layer]

| | |
|---|---|
| Acetic-acid aqueous solution | 136.0 parts |
| (Manufactured by Daicel Chemical Industries Ltd., 1% | by mass |
| aqueous solution of industrial acetic acid) | |
| 3-glycidoxypropyltrimethoxysilane | 53.2 parts |
| (Manufactured by Shin-Etsu Chemical Co., Ltd., KBE-403) | by mass |
| Tetramethoxysilane | 61.8 parts |
| (Manufactured by Shin-Etsu Chemical Co., Ltd., KBE-04) | by mass |
| Colloidal silica | 542.4 parts |
| (Manufactured by Nissan Chemical Industries Co., Ltd., | by mass |
| SNOWTEX OS, solid content of 20%) | |
| Curing agent | 1.8 parts |
| (Manufactured by Kawaken Fine Chemical Co., Ltd., | by mass |
| Alumichelate A (W)) | |
| Surface active agent C | 20.6 parts |
| (Manufactured by Sanyo Chemical Industries, Ltd., 10% | by mass |
| aqueous solution of Sanded BL, anionic) | |
| Surface active agent B | 60.0 parts |
| (Manufactured by Sanyo Chemical Industries, Ltd., 1% | by mass |
| aqueous solution of Naroacty CL-95, nonionic) | |
| Acrylic resin fine particles | 25.8 parts |
| (Manufactured by Soken Chemical & Engineering Co., Ltd., | by mass |
| MX-80H3WT, average particle diameter of 0.8 μm, CV | |
| value of 9%) | |
| Acrylic resin fine particles | 25.8 parts |
| (Manufactured by Soken Chemical & Engineering Co., Ltd., | by mass |
| MX-150, average particle diameter of 1.5 μm, CV | |
| value of 9%) | |
| Acrylic resin fine particles | 25.8 parts |
| (Manufactured by Soken Chemical & Engineering Co., Ltd., | by mass |
| MX-180, average particle diameter of 2.0 μm, CV | |
| value of 9%) | |
| Distilled Water | added so as to |
| | achieve 1000 |
| | parts by mass |
| | in total |

### Eighth Comparative Example

As a coating fluid for the second transparent layer, in place of the one in the first example, a coating fluid for the second transparent layer formed of the composition described below was subsequently applied on the first transparent layer by the bar coat method. The amount of coating was 8.0 cc/m², and drying was performed at 100° C. for one minute. With this, the second transparent layer having an average film thickness of approximately 1.7 μm was formed.

| | |
|---|---|
| Diluent | 285.0 parts |
| (MEK (methyl ethyl ketone)) | by mass |
| Polyester resin | 712.5 parts |
| (PESRESIN S110, manufactured by Takamatsu Oil & Fat | by mass |
| Co., Ltd., solid content of 30%) | |
| Acrylic resin fine particles | 2.5 parts |
| (Manufactured by Soken Chemical & Engineering Co., Ltd., | by mass |
| MX-300, average particle diameter of 3 μm, CV | |
| value of 9%) | |

When observed by a light microscope, 1100 particles/mm² were measured, and therefore an average space between particles was 30 μm.

### Ninth Comparative Example

As a coating fluid for the second transparent layer, in place of the one in the first example, a coating fluid for the second transparent layer formed of the composition described below was subsequently applied on the first transparent layer by the bar coat method. The amount of coating was 5.0 cc/m², and drying was performed at 100° C. for one minute. With this, the second transparent layer having an average film thickness of approximately 1.2 μm was formed.

| | |
|---|---|
| Diluent | 280.9 parts |
| (MEK (methyl ethyl ketone)) | by mass |
| Polyester resin | 702.2 parts |
| (PESRESIN S110, manufactured by Takamatsu Oil & Fat | by mass |
| Co., Ltd., solid content of 30%) | |
| Acrylic resin fine particles | 6.9 parts |
| (Manufactured by Soken Chemical & Engineering Co., Ltd., | by mass |
| MX-300, average particle diameter of 3 μm, CV | |
| value of 9%) | |

[Evaluation]

The optical laminate films obtained in the first to sixth examples and the first to ninth comparative examples were evaluated as follows.

[Haze Value]

In the examples of the optical laminate film 10, a haze meter (NDH-2000, Nippon Denshoku Industries Co., Ltd.) was used, and hazes were measured according to JIS-K-7105.

Note that in the examples of the optical laminate film 20, a measurement can be performed with the film being completely flattened with a fluid having a refractive index equal to that of the lens layer (such as matching oil).

[Volume Average Particle Diameter]

With an optical microscope, a diameter Di of each of particles and the number of particles ni were measured within a range of 1 cm², and a volume average particle r was calculated as r=Σ(Di×Di³×ni)/Σ(Di³×ni).

Also, when a measurement with the optical microscope was difficult, a SEM or the like was used as appropriate to calculate a particle diameter from images of the surface and section of the film.

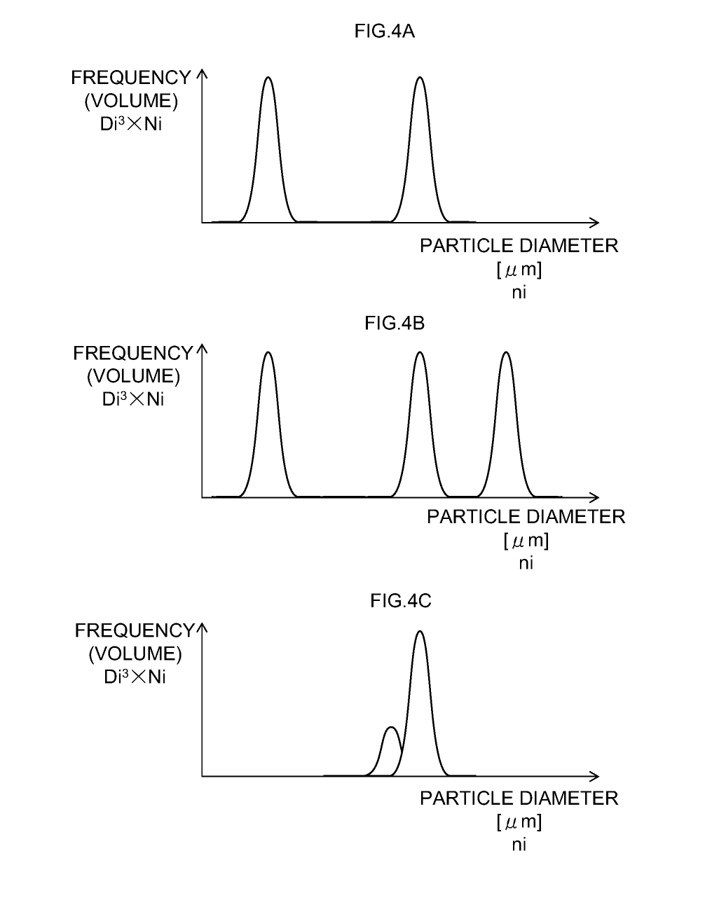

Furthermore, with each particle diameter Di being taken as a horizontal axis and a volume frequency Di³×ni of each particle being taken as a vertical axis, when particles having different particle diameters are mixed together, a plurality of peaks are present as shown in FIGS. 4A, 4B, and 4C. FIG. 4A shows the case in which two types of translucent particles having different particle diameters are contained. FIG. 4B shows the case in which three types of translucent particles having different particle diameters are contained. FIG. 4C shows the case in which two types of translucent particles having different particle diameters are contained, a difference in particle diameter between the translucent particles is small, and a difference in the number of each type of translucent particles is present.

[Amount of Addition of Translucent Particles]

Measurements were performed with a method similar to that for measuring a volume average particle diameter. With a relative density of each particle being taken as Ai, the amount of addition was calculated as S (mg)=10×4π/3×Σ{Ai×ni×(Di/2)³}.

[Average Film Thickness of Transparent Layer]

A sectional photograph of the film was shot by SEM with the number of items allowing the film thickness to be measured without variation, the thickness of each part was measured, and the obtained values were averaged to find an average film thickness.

[10-Point Average Roughness]

10-point average roughness (Rz) was set by using a stylus-type surface roughness measuring instrument “HANDY SURF E-35B” (manufactured by Tokyo Seimitsu Co., Ltd.) according to JIS B-0601, and values derived from the surface roughness measuring instrument were adopted.

[Rainbow-Like Unevenness]

The backlight of BRAVIA (trademark, model number: KDL-40NX800) manufactured by SONY Corporation was taken out so that the backlight can be lit up, and each sample was arranged on the backlight, with the prism layer being placed outside. Then, evaluation was visually made as to the degree of color unevenness in a boundary region between a bright part and a dark part viewed in a direction perpendicular to a direction in which the prisms of the prism layer is on a line and when a line of sight is titled at approximately 30° from a straight above direction.

A: Little color unevenness can be viewed.
B: Slight color unevenness can be viewed.
C: Significant color unevenness can be viewed.

[Particle Missing]

With an abrasion-resistance test machine (manufactured by SHINTO Scientific Co., Ltd.), missing or falling of particles (particle missing or particle falling) were evaluated. Specifically, black paper (manufactured by FUJI FILM Corporation, SKBT 3 90BIG0) was brought into contact with a coating surface on a back surface side and, with a load of 3 kg per 30 mm×25 mm being applied, the surface was rubbed for a distance of 10 cm at 100 cm/minute. After the rubbing test, a level of white powder attached onto the black paper was visually evaluated.

A: A trace amount of white powder or none is attached.
B: A slight amount of white powder is attached
C: A significant amount of white powder is attached

[Outer Appearance (Coating Surface)]

A fluorescent lamp was prepared as a light source, a sample was placed at a position several tens of cm away from the light source, and the coated product was observed under a condition of letting light from the light source pass through. Note that the coated product visually evaluated was in a state before mounting prisms and had a width of 30 cm and a length of 2 m as an evaluation size.

A: Little surface unevenness can be viewed.
B: Slight surface unevenness can be viewed.
C: Significant unevenness can be viewed.

Table 1 summarizes conditions and evaluation results of examples and comparative examples. In the first to fourth examples, the total sum S of the translucent particles satisfied 30 mg/m²≦S≦500 mg/m² and two or more types of particles were contained, and therefore rainbow-like unevenness, outer appearance, particle missing are evaluated as A. In the fifth example, rainbow-like unevenness is evaluated as B. In the sixth example, particle missing is evaluated as B. However, other performances in the fifth and sixth examples are evaluated as A. In the sixth comparative example, two or more types of particles were contained, but the amount of addition was smaller than 30 mg/m², and therefore rainbow-like unevenness is evaluated as C. In the seventh comparative example, two or more types of particles were contained, but the amount of addition was larger than 500 mg/m², and therefore particle missing is evaluated as C. In the first and eighth comparative example, only one type of particles was contained and the amount of addition of the particles was smaller than 30 mg/m², and therefore rainbow-like unevenness and the outer appearance are evaluated as C. In the second comparative example, only one type of particles was contained and the amount of addition of the particles was larger than 500 mg/m², and therefore particle missing is evaluated as C. In the third comparative example, only one type of particles was contained and the film thickness was smaller than ¼ of the particle diameter, and therefore the outer appearance and particle missing are evaluated as C. In the fourth comparative example, only one type of particles was contained and the film thickness was larger than the particle diameter, and therefore rainbow-like unevenness is evaluated as C. In the fifth and ninth comparative examples, only one type of particles was contained, and therefore the outer appearance is evaluated as C.

Note that, as can be seen from the second example and the fifth and ninth comparative examples, it is difficult to improve the outer appearance merely by improving the haze.

TABLE 1

| | | | | | AVERAGE | | | | |
|---|---|---|---|---|---|---|---|---|---|
| | | | | | FILM | | | | |
| | | | MAXIMUM | AMOUNT | THICK- | | | | |
| | | VOLUME | DIFFERENCE | OF | NESS | 10-POINT | RAINBOW- | OUTER | |
| | | AVERAGE | IN AVERAGE | ADDITION | OF TRANS- | AVERAGE | LIKE | APPEAR- | |
| | HAZE | PARTICLE | PARTICLE | OF | PARENT | ROUGH- | UNEVEN- | ANCE | |
| | VALUE | DIAMETER | DIAMETER | PARTICLES | LAYER | NESS | NESS | (COATING | PARTICLE |
| | (%) | (μm) | (μm) | (mg/m²) | (μm) | (μm) | (μm) | SURFACE) | MISSING |
| FIRST | 42 | 1.1 | 1.5 | 180 | 1.0 | 0.7 | A | A | A |
| EXAMPLE | | | | | | | | | |
| SECOND | 29 | 1.4 | 1.2 | 100 | 1.0 | 0.9 | A | A | A |
| EXAMPLE | | | | | | | | | |
| THIRD | 43 | 1.3 | 1.1 | 225 | 1.1 | 0.6 | A | A | A |
| EXAMPLE | | | | | | | | | |
| FORTH | 40 | 1.4 | 1.1 | 225 | 1.1 | 0.7 | A | A | A |
| EXAMPLE | | | | | | | | | |
| FIFTH | 25 | 1.6 | 1.1 | 60 | 1.1 | 0.8 | B | A | A |
| EXAMPLE | | | | | | | | | |
| SIXTH | 60 | 1.4 | 1.2 | 500 | 1.2 | 0.9 | A | A | B |
| EXAMPLE | | | | | | | | | |
| FIRST | 11 | 1.5 | — | 25 | 0.8 | 0.7 | C | C | A |
| COMPARATIVE | | | | | | | | | |
| EXAMPLE | | | | | | | | | |
| SECOND | (90) | 3 | — | 700 | 2.3 | (0.9) | A | A | C |
| COMPARATIVE | | | | | | | | | |
| EXAMPLE | | | | | | | | | |
| THIRD | (40) | 1.5 | — | 70 | 0.3 | (1.2) | A | C | C |
| COMPARATIVE | | | | | | | | | |
| EXAMPLE | | | | | | | | | |
| FORTH | 31 | 4 | — | 400 | 8 | 0.3 | C | A | A |
| COMPARATIVE | | | | | | | | | |
| EXAMPLE | | | | | | | | | |
| FIFTH | 35 | 1.5 | — | 100 | 0.9 | 0.8 | A | C | A |
| COMPARATIVE | | | | | | | | | |
| EXAMPLE | | | | | | | | | |
| SIXTH | 10 | 1.4 | 1.2 | 25 | 1 | 0.9 | C | A | A |
| COMPARATIVE | | | | | | | | | |
| EXAMPLE | | | | | | | | | |
| SEVENTH | 85 | 1.4 | 1.2 | 600 | 1 | 0.9 | A | A | C |
| COMPARATIVE | | | | | | | | | |
| EXAMPLE | | | | | | | | | |
| EIGHTH | 15 | 3 | — | 20 | 1.7 | 2 | C | C | A |
| COMPARATIVE | | | | | | | | | |
| EXAMPLE | | | | | | | | | |
| NINTH | 40 | 3 | — | 80 | 1.5 | 2 | A | C | A |
| COMPARATIVE | | | | | | | | | |
| EXAMPLE | | | | | | | | | |

What is claimed is:

1. An optical laminate film comprising:
a support;
an easily-adhesive layer provided on one surface of the support; and
a transparent layer made of translucent resin provided on another surface of the support, wherein
the transparent layer contains at least two types of translucent particles having different volume average particle diameters, and
a total sum S of the translucent particles satisfies 30 mg/m²≦S≦500 mg/m².

2. The optical laminate film according to claim 1, wherein, among the translucent particles, a translucent particle having a smallest volume average particle diameter and a translucent particle having a largest volume average particle diameter have a difference in volume average particle diameter equal to or larger than 1 μm.

3. The optical laminate film according to claim 1, wherein a volume average particle diameter r of all of the translucent particles satisfies 1.0 μm≦r≦3.0 μm.

4. The optical laminate film according to claim 1, wherein an average film thickness t of the transparent layer satisfies r/4≦t<r, with respect to a volume average particle diameter r of all of the translucent particles.

5. The optical laminate film according to claim 1, wherein a haze value is equal to or larger than 20% and equal to or smaller than 60%.

6. The optical laminate film according to claim 1, wherein at least one of the translucent particles has a CV value of equal to or lower than 30%, and the CV value is defined as follows:
CV value=[standard deviation of volume average particle diameter of the translucent particles]/[average particle diameter of the translucent particles].

7. The optical laminate film according to claim 1, wherein at least one of the translucent particle has a volume average particle diameter smaller than 1 μm.

8. The optical laminate film according to claim 1, wherein the transparent layer includes two layers of from a side close to the support, a first transparent layer and a second transparent layer.

9. The optical laminate film according to claim 1, wherein the second transparent layer is an inorganic layer made of a silica-based compound.

10. The optical laminate film according to claim 1, wherein
the transparent layer includes either one of metal oxide particles exhibiting conductivity by electron conduction and a π electron-conjugated conductive polymer, and
the transparent layer has a surface resistance equal to or lower than 10¹²Ω/sq.

11. The optical laminate film according to claim 1, wherein
the easily-adhesive layer includes either one of metal oxide particles exhibiting conductivity by electron conduction and a π electron-conjugated conductive polymer, and
the easily-adhesive layer has a surface resistance equal to or lower than 10¹²Ω/sq.

12. The optical laminate film according to claim 1, further comprising
a lens layer on the easily-adhesive layer.

13. The optical laminate film according to claim 1, wherein the transparent layer has a 10-point average roughness Rz of 0.5 μm≦Rz≦1.0 μm.

14. A display device comprising the optical laminate film according to claim 1 mounted thereon.
